(19) United States
(12) Patent Application Publication
(10) Pub. No.: US 2009/0024414 A1
(43) Pub. Date: Jan. 22, 2009

(54) Analytical methods and software product for automated health care information systems

(75) Inventors: Richard P. Mansour, Shreveport, LA (US); Francis E. Brindel, Watertown, MA (US); Paul Kohlmiller, Gilroy, CA (US); Raisa Ifraimov, Waltham, MA (US); Michael Van Schaick, Clifton Park, NY (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Eclipsys Corporation

(21) Appl. No.: 11/879,664

(22) Filed: Jul. 17, 2007

(51) Int. Cl. G06Q 50/00; G06F 17/30; G06F 17/40

(52) U.S. Cl. 705/3; 705/2

(57) ABSTRACT

A computer software application and methods for facilitating analysis of clinical data (e.g., patient or patient care information) stored in a clinical database is disclosed. The application includes a process extracting clinical data from the clinical database and loading the extracted data into an analytics database. The application further configures the analytics database in accordance with a data model that is optimized for business intelligence reporting tools, e.g., in the form of multidimensional data cubes which can be derived from tables of data. The application further includes procedures (e.g., SQL procedures) for applying clinically related logical rules to the clinical data and storing flags associated with the logical rules in the analytics database.

### BACKGROUND

1. Field

This invention relates generally to the field of computerized medical records management systems, and in particular to methods for facilitating analysis of clinical information in a medical records database.

2. Description of Related Art

In the medical arena, hand written patient record keeping systems have evolved through many years of careful refinement and enhancement into systems which maintain a detailed manual record of medical information concerning each patient. To meet the needs of different hospital entities (such as doctors, nurses, pharmacy, accounting, laboratory, etc.) a manual record keeping system often requires that one piece of information be entered into multiple records. In addition it often requires that the same information that has not changed from visit to visit (such as family/social history, allergies, immunization status) be re-asked of the patient and re-documented in the current record. In certain instances, such as in the Emergency Department (ED), this information may be asked and recorded as many as three separate times (on the Triage Note; the main ED record; and MD documentation) leaving the patient to wonder if there is any communication between healthcare providers and frustrating those healthcare providers who must fill out more and more paperwork. If the patient is admitted, this same information is then asked and recorded again by the admitting nurse and attending physician.

In a typical manual patient record keeping system a patient chart, usually in the form of a notebook, is maintained at the nursing station for each patient. The notebook is divided into a plurality of individual tabbed sections, such as Physicians Orders, Nursing Care Plan, Nursing Assessment, and Laboratory.

Each of the above sections is further subdivided into a number of forms. The forms are those which are appropriate to the individual patient and/or such patient's physician. For example, within the Laboratory section there may appear forms for chemistry, hematology, blood gas, and microbiology.

In addition, a “flowsheet” chart is usually kept at the patient's bedside, particularly in a critical care environment. On the “flowsheet” chart there are individual areas for medication records, vital signs, intake/output, laboratory results, and other categories which are dependent upon the patient's affliction, such as intravenous (IV) drips.

Referring in particular to nursing functions, annotations to charts and/or nursing progress notes are made manually. Typically, brief notations are jotted down in various places through-out a shift. Sometime during the shift, typically at the end, the nurse makes a full notation into the nursing progress notes based on the brief notations or remembered items. This process can be very inefficient since notations may be forgotten or not copied appropriately. In particular, documentation and entry of physician orders, prescriptions and other activity has been viewed as two separate activities or steps, one step completing the documentation and a second step of entry of the order or prescription in the medical records of the patient.

The need for more efficiency of workflow and coordination between multiple departments and healthcare providers in a hospital environment has led to the advent of computerized medical records applications and related systems. Medical records management systems are known in the art and include the systems disclosed in the following U.S. Pat. Nos.: 5,325,478; 5,247,611; 5,077,666; 5,072,383 and 5,253,362 all assigned to the assignee of this invention, and have been commercialized by the Assignee of this invention and others.

The foregoing examples of the related art and limitations related therewith are intended to be illustrative and not exclusive. Other limitations of the related art will become apparent to those of skill in the art upon a reading of the specification and a study of the drawings.

### SUMMARY

In a first aspect, a medical records information apparatus is provided which facilitates analysis of clinical data (e.g., patient or patient care information) stored in a clinical database. The apparatus is in the form of a software application comprising a set of machine readable code stored on a machine readable medium and executable on a computing platform. The application is referred to herein as an analytics module.

The application includes a process extracting clinical data from the clinical database and loading the extracted data into an analytics database. The analytics database is separate from the clinical database. A separate analytics database is used in order such that the use of the analytics database (e.g., by hospital medial personnel or administrators) does not adversely impact the ongoing use and updating of the clinical database. The application further configures the analytics database in accordance with a data model that is optimized for business intelligence reporting tools, such as commercially available software reporting applications providing display of multidimensional data e.g., in the form of multidimensional data cubes. The application further includes procedures (e.g., SQL procedures) for applying clinically-related logical rules to the clinical data and storing flags associated with the logical rules in the analytics database.

In one possible arrangement of the analytics database, the data model by which the analytics database is structured includes a plurality of fact tables storing clinical data and the flags associated with the logical rules. In another possible arrangement, the data model further includes a plurality of dimension tables. A commercially available database software tool such as MICROSOFT SQL SERVER ANALYSIS SERVICES™ operates on the fact and dimension tables to create multidimensional on-line analytics processing (OLAP) cubes, which are a suitable format for commercially available business intelligence reporting tools. The data can also be organized into data marts including at least one of an orders data mart, a quality measures data mart, a clinical decision support datamart, and an inpatient admission data mart.

As noted, the analytics database is ideally separate from the clinical database. In a typical implementation, e.g., in a hospital environment, the clinical database is continually updated with new patient admissions, new tests results for patients, new orders being prescribed, and other events in the episode of patient care for a multitude of patients served by the hospital. The analytics module application further includes an update process by which clinical information in the analytics database is periodically updated from information in the clinical database. This update process could run on a daily basis, a weekly basis, or on some other periodic interval.

The logical rules setting the clinically-related flags can be tailored by the system administrator of the application. The flags can be used to create additional meaning and context to information in the clinical database. For example, the flags may include one or more flags designed to profile a patient for a chronic illness, e.g., based on the occurrence (or non-occurrence) of a set of events in the episode of patient care. As another example, the flags may include one or more flags designed to profile compliance with quality measures for care of a patient, such as quality measures set by an industry or governmental organization.

Another aspect of the invention relates to a method of facilitating analysis of clinically relevant information contained in a clinical database. The method includes the steps of: performing a backup step including creating a backup to the clinical database to thereby provide a source database for a data extraction program; performing an extract step including executing the data extraction program and responsively creating a set of metadata tables and extracted source tables; performing a load step including executing a plurality of procedures to move data from the extracted source tables into a plurality of tables of an analytics database; and wherein the procedures further include procedures applying clinically related logical rules to the data in the extracted source tables and storing flags associated with the logical rules in one or more of the plurality of tables of the analytics database. The method of this aspect of the invention can be coded as a set of software instructions and provided to a health care enterprise as a separate analytics software product for use with a pre-existing medical records information application maintaining the clinical database.

In one embodiment, the plurality of tables includes a plurality of fact tables which store among other things the flags and a plurality of so-called dimension tables. The fact tables include at least one of a patient visits table, an orders table, a clinical decision support table, and a cardiology-related table. The dimension tables store time-related data, or clinical data organized by time period, such as on a yearly, monthly, weekly or shift.

In another embodiment, the method includes providing a facility by which an organization practicing the method may customize the clinically related logical rules. The facility may consist of a user interface to the analytics module which allows an administrator to program the logical rules and add new rules to an existing set of rules.

In yet another aspect of the invention, a system for medical records management is disclosed comprising a computer system including a computing platform executing a medical records information application maintaining a clinical database. The system further includes software (program instructions) stored on a machine readable medium accessible to the computing platform which creates an analytics database separate from the clinical database. The analytics database is configured in accordance with a data model optimized for business intelligence reporting tools. The analytics database further includes a plurality of flags set by the application of clinically-related logical rules to the clinical data.

In one embodiment the data model includes a plurality of fact tables storing clinical data and the flags associated with the logical rules. In another embodiment the data model includes a plurality of dimension tables. The database can also be configured into one or more OLAP multi-dimensional data cubes.

In addition to the exemplary aspects and embodiments described above, further aspects and embodiments will become apparent by reference to the drawings and by study of the following detailed descriptions. Moreover, the exemplary embodiment will be described in conjunction with representative and non-limiting examples of user interfaces by which information in the analytics database is presented to the user. Persons skilled in the art will recognize that variation from the specifics of the disclosed embodiments and user interface design is possible without departure from the teachings herein.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 is a block diagram of a computerized medical records system for a plurality of patients cared for in a medical facility in accordance with one embodiment of the invention. The system includes a main clinical database containing medical records for patients and an analytics database. The analytics database provides a clinical data warehouse that allows for simplified access to clinical data for employees of the facility using conventional business intelligence applications, without compromising the performance of the medical records system and operation or accessibility of the clinical database.

FIG. 2 is a schematic representation of a portion of the clinical database of FIG. 1, showing an electronic patient record for patient X, with the recording including a number of fields or categories, each associated with a different portion of the database record. These categories, which may be user or customer defined, include categories such as Orders, Documents, Prescriptions, Allergies and still others. The illustration of FIG. 2 shows a relational database implementation wherein data is organized in rows and columns. However, the use of object-oriented database design in which data is stored as objects is an alternative implementation.

FIG. 3A is a high level overview of a preferred embodiment of an analytics software module in accordance with this disclosure and its relationship to a clinical manager maintaining the clinical database of FIGS. 1 and 2 and the workstations of the medical facility of FIG. 1.

FIG. 3B is a schematic diagram of the analytics database of FIGS. 1 and 3A.

FIGS. 4A and 4B are a high level data flow diagram showing the steps in creation of the analytics database of FIG. 3B.

FIG. 5 is an illustration of a Cardio Note fact table stored in the analytics database of FIGS. 1 and 3A and showing its relationship to other tables in the database.

FIG. 6 is an illustration of a Clinical Decision Support fact table stored in the analytics database and showing its relationship to other tables in the database.

FIG. 7 is an illustration of an Order fact table stored in the analytics database and showing its relationship to other tables in the database.

FIG. 8 is an illustration of a Visit fact table stored in the analytics database and showing its relationship to other tables in the database.

FIG. 9 is an illustration of the metadata tables stored in the analytics database.

FIG. 10 is an illustration of supporting list tables stored in the analytics database.

FIG. 11 is a screen shot of a visit discharge and patient information briefing book presented on a display of one of the workstations of FIG. 1, showing the display of information in the OLAP cubes for the Visit datamart in the analytics database. The briefing book allows the user to inspect a variety of user-defined reports from data in the OLAP cubes.

FIG. 12 is a screen shot of a visit health issue and observation briefing book presented on a display of one of the workstations of FIG. 1, showing the display of information in OLAP cube for the Visit datamart in the analytics database.

FIG. 13 is a screen shot of an Orders briefing book presented on a display of one of the workstations of FIG. 1, showing the display of information in the OLAP cube for the Orders datamart in the analytics database.

FIG. 14 is a screen shot of a Clinical Decision support briefing book presented on a display of one of the workstations of FIG. 1, showing the display of information in the OLAP cube for the Clinical Decision Support datamart in the analytics database.

FIG. 15 is a screen shot of a JCAHO quality measures briefing book presented on a display of one of the workstations of FIG. 4, showing the display of information in the OLAP cube for the JCAHO quality measures datamart in the analytics database.

FIG. 16 is an illustration of additional optional software modules which may be present in the analytics module of FIG. 2.

### DETAILED DESCRIPTION

Overview

This invention relates to a method and system for providing health care practitioners, clinical researchers, as well as health care administrators and support staff, access to clinically relevant information stored in a clinical database, such as a database of medical records of patients that have been admitted to a hospital over some period of years. The methods of this disclosure allow all the relevant information in a clinical database to accessed and utilized to meet substantially all of their data manipulation and reporting needs, using commercially available business intelligence (BI) report writer or presentation tools such as PROCLARITY™ or MICROSOFT SEQUEL REPORTS™, both available from Microsoft Corporation of Redmond, Wash. Unlike the situation in the past, however, the methods of this invention allow the aggregation and communication of massive amounts of data without impacting the performance of the clinical database, e.g., slowing it down. Additionally, the methods of this invention allows for simplified access to clinical data. It features a full replication of the relevant clinical data into a separate analytics environment (analytics database) as well as the creation of OLAP data cubes for use with business intelligence tools for effective report writing.

A motivation behind the development of this invention is to offer medical enterprises, such as hospitals and other health care organizations, with a tool to reorganize and make accessible the data they collect in their main clinical database. The data is reorganized by copying it from the main clinical database into an analytics database, and in the process transforming or configuring it into a data model which is optimized for Business Intelligence (BI) reporting tools, such as the two products mentioned above. One significant part of this transformation of the data is the use or setting of clinically-related flags and storing such flags in the analytics database. Accessibility to the analytics database is offered to users of the systems through the creation of reports such as “briefing books” derived from the cubes, again using commercially available software tools.

The use of clinically related-flags will be explained in more detail below, but in essence the flags provide a methodology by which the administrator or user of the system to set values related to clinically relevant data. The flags are imported into and made a part of the data structures of the analytics database (for example, entries in the fact tables as explained below) and thus are accessible to the BI reporting tools. Consider the typical situation where many transactions related to a patient occur over an episode of care, from admission, test results, orders, diagnoses, discharge, follow up care, and so forth. The method applies a test to particular information in the episode of care that determines the presence or absence of a specific event (e.g., a particular meaningful lab test value), either at any time or at a specific point in time of an episode of care. If the test criteria for the event (e.g., medical data, lab result, order, etc.) is met, then the method sets a flag (e.g., a discrete piece of data, such as a “1”), which means that the event occurred. If the test criteria is not met, it sends another type of flag or discrete set of data, e.g., a “0”.

For example, consider the situation where a patient is admitted to the hospital for pneumonia and stays seven days. One of the events that can be flagged was whether an appropriate antibiotic was ordered for the patient within four hours after admission. The software of this system examines all the orders for the patient (such orders being data contained in the clinical database) and looks for any one of the appropriately tagged antibiotics that is ordered within four hours of admission. It may find none, one, two, three, or more antibiotics tagged for pneumonia that have been ordered within four hours. If it finds at least one, it sets a flag of “1” and includes the flag in the Orders fact table which is stored in the analytics database. If it finds the correct antibiotic but it was not ordered within four hours, it sets a flag of “0” and the “0” is reflected in the Orders fact table. The flag is part of the Orders OLAP cube and thus presented to the user when they view an Orders briefing book on their workstation.

Obviously, this is just one example of the many different types of flags can be established when establishing the analytics database. The user of the system is allowed to define the flags, and can define any arbitrary number of them.

As another example, the analytics product could profile a patient for chronic illness by setting flags of “0” or “1” relating to codes or indicia that would indicate a certain type of illness, e.g., whether the patient is a smoker, whether they tested positive in some type of test, e.g., presence of HIV virus, whether they have certain medical conditions, etc. For example, there could exist up to twenty codes that indicate whether a patient has a history of diabetes. The analytics program applies a test to episode of care information relating to all 20 codes, and then returns a flag of either “0” or “1” for history of diabetes, and stores the flags in the analytics database.

Thus, the flags may include one or more flags designed to profile a patient for a chronic illness, e.g., based on the occurrence (or non-occurrence) of a set of events in the episode of patient care. As another example, the flags may include one or more flags designed to profile compliance with quality measures for care of a patient, such as quality measures set by an industry or governmental organization, e.g., whether an appropriate antibiotic was prescribed for a patient diagnosed with pneumonia within four hours of admission. This processing provides a strategy which is well suited to transform electronic medical record information in a clinical database to a format of information that is suitable to be transformed into data cubes, and suitable for interpretation by commercially available business intelligence objects or reporting tools.

To summarize, the methodology and software products described in this disclosure provide for extracting electronic medical records (electronic health records) in a clinical database and configuring the data into a new format in an analytics database suitable for use by business intelligence reporting tools. The methodology is flexible and configurable so that the organization implementing the methods and software can have flexibility over the criteria to apply to the medical information when setting the flags during the data extraction process—basically, the organization can specify any criteria it wants to. The analytics application is totally configurable in order to allow the organization to identify both the subject area in the clinical data, and the flag-setting test to be applied to particular clinical data. Thus, the organization can configure the meaning of the information contained in the electronic health records that is transferred to the analytics database.

The methods of this disclosure have a variety of uses in the medical setting. For example, it facilitates in-depth analysis of patient visits, orders given to patients, and clinical decision support, by health care researchers, practitioners, and hospital administrators. It further facilitates in-depth analysis of a hospital's compliance with quality measurements for hospital care and ambulatory care, such as those required by the Joint Commission on Accreditation of Hospitals (JCAHO), standards of the Centers for Medicare and Medicaid (CMS) for management of patients in Medicare and Medicaid programs, and health care standards mandated by health insurance companies, employers, or other payers of health care.

With the above overview in mind, this disclosure will initially present a description of one representative example of an environment in which the invention can be practiced, namely a hospital environment in which a clinical database of electronic patient records is created and maintained by a principal medical records application used throughout the hospital. The discussion will proceed to explain the analytics software which interacts with the medical records application, including the process of creation of the analytics database, and the features of the database, including fact tables, dimension tables and the clinically-related flags which are set and stored in the fact tables. The following sections will also explain what is being done to the extracted clinical data from the clinical database in order to present it as compiled information in the analytics database. The compilation process includes a series of logical rules, coded as SQL procedures, which set the clinically-related flags. The discussion will then turn to the business intelligence reporting tools by which information in the analytics database may be presented to the user.

System Overview and Creation of Clinical Database 18

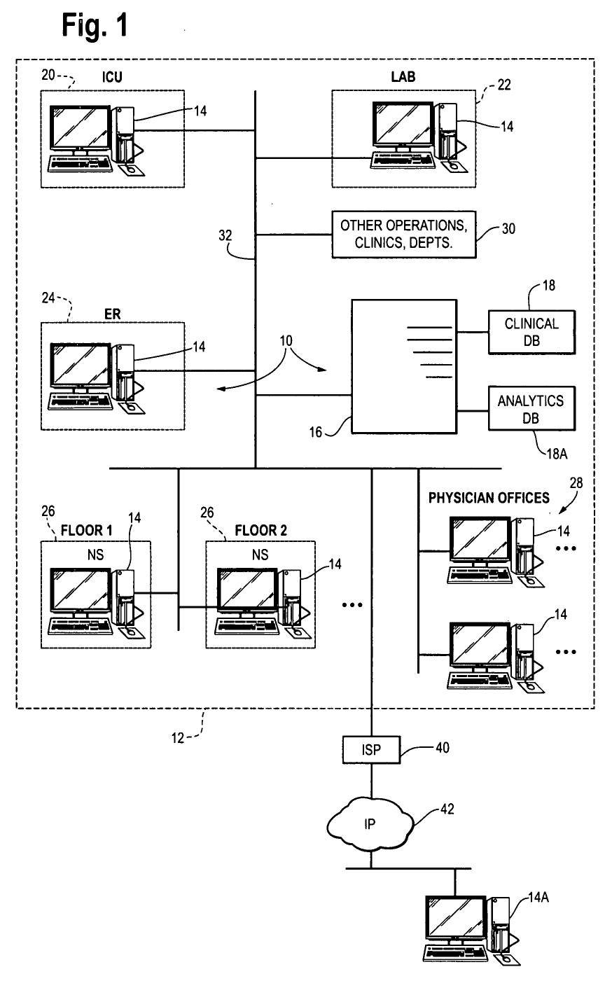

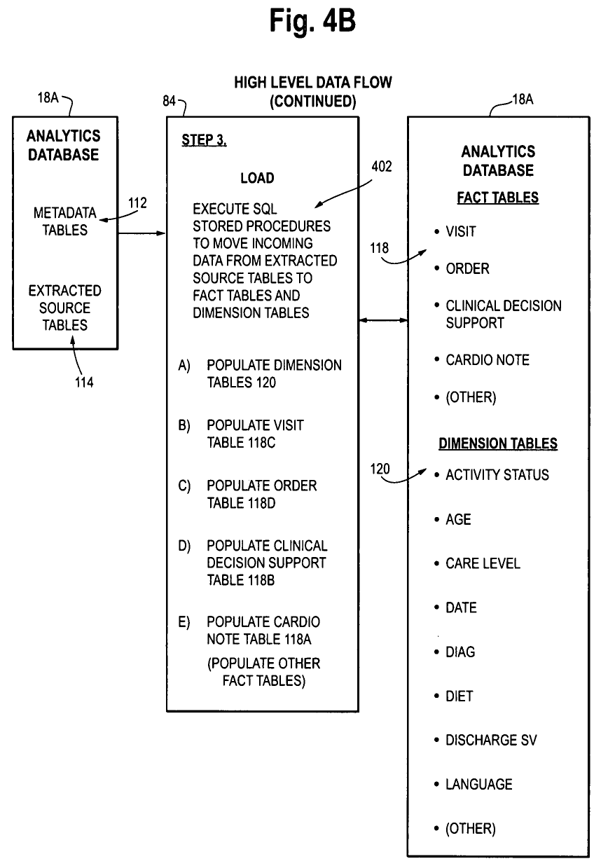

Referring now to FIG. 1, a representative and non-limiting example of an environment in which the invention can be practiced is shown in block diagram format. In particular, FIG. 1 depicts a computerized medical records system 10 that is used by clinicians (physicians, nurses and other medical personnel) and hospital administrators. The system is shown installed in a medical facility 12. The medical facility may for example be a hospital, nursing home, clinic, or other medical enterprise. The details on the medical enterprise and type of health care services it may render to patients are not particularly important. A primary application of this invention is in the hospital environment, and therefore the following description will be made in conjunction with a hospital. The invention is useable across all venues of patient care and is not limited to the hospital. Other venues in which this invention can be implemented will include ambulatory office practice, critical care, emergency departments and chronic care facilities such as nursing homes and potentially home care. As will be appreciated by persons skilled in the art, the supporting data model shown in FIGS. 5-10 of this disclosure may vary from the illustrated model if the invention is implemented in these other venues. However, persons skilled in the art will be able to adapt the data model to fit such other venues.

The medical records system 10 includes a plurality of distributed workstations or client computers 14, a central database server 16 and a clinical database 18 containing electronic patient records. The workstations 14 could be for example general purpose computers with a processing unit and graphical display unit. The workstations 14 could also be hand-held computers. The workstations 14 include a memory storing an interactive, client-server based patient documentation application that is executed by the processor in the workstation. The application provides user interface tools in the form of graphical screen displays which allow the user access the electronic patient records stored in the clinical database and add clinical documentation regarding a patient being treated at the facility 12.

As shown in FIG. 1, the facility 12 may include an Intensive Care Unit 20 with one or more workstations 14, which may be used by ICU physicians and ICU nurses to access patient records and input orders, write prescriptions, view patient allergies, and input documentation. The facility may also include one or more laboratories 22, each of which may include a workstation 14. Lab personnel may input test results into the patient record stored in the database 18. The facility may also include an Emergency Room (ER) 24, where one or more workstations 14 are provided for ER clinicians to record and input orders, write prescriptions, view patient allergies, note significant events and chief complaints of the patients and input them into the electronic patient record stored in the database 18. The facility may also have a number of patient rooms and provide nurses stations (NS) 26 on each floor, each of which has a workstation 14. Additionally, physicians' offices 28 may also include workstations 14, e.g., in the form of personal computers. The facility 12 may have other operations, clinics, departments, etc. as indicated at 30, each of which may be provided with additional workstations 14. The workstation are networked on a local area network 32 wherein all of the workstations may exchange data with the central database server 16 and thereby access the patient records stored in the clinical database 18 and write documentation and orders, prescriptions, and use or add information to the database 18.

The network 32 may include a router (not shown) providing a connection to an internet service provider (ISP) 40 providing access to an external wide area Internet Protocol network 42 such as the Internet 42. A workstation 14A may be coupled to the enterprise network 32 via the ISP 40 whereby a clinician authorized to access patient records in the database 12 may do so via the Internet 42, ISP 40 network access server and local area network 32. Thus, a workstation 14, 14A creating patient documentation need not necessarily physically reside on the network 32 or be physically located within or at the enterprise 12.

Thus, the medical records system 10 that is installed in the medical facility 12 allows clinicians to access patient records in a clinical database 18. The system 10 may take the form of a hospital medical records information system, and such systems are generally known in the art and commercially available from Eclipsys Corporation, Siemens, and others. The preferred embodiment of such a system provides clinicians information they need, when and where they need it—at the point of care (e.g., in the ER or at the nursing stations 26), in the offices 28, even at home via a computer 14A and the Internet 42.

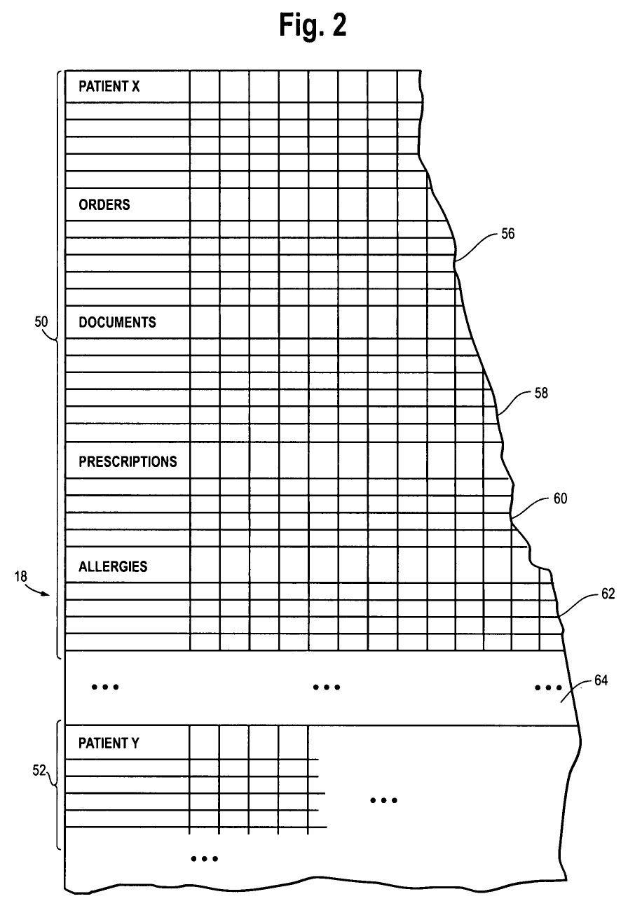

A schematic representation of the clinical database 18 is shown in FIG. 2. The database includes a multitude of electronic patient records 50, 52 each comprising rows and columns of data. A first field 54 is shown directed to patient information, such as name, address, insurance carrier, date of birth, etc.

A second field 56 contains orders for the patient. The orders are determined by health care personnel treating the patient. Each row in the orders field 56 may constitute a specific order, and the various columns in the row devoted to different aspects of the order, such as the entering physician's name, the type of order, the date it was placed, etc.

A third field 58 is directed to documents (i.e., documentation) entered by a physician or nurse. Each row may represent specific instances of documentation created by a user.

A fourth field 60 contains prescription medications ordered for the patient. A fifth field 62 contains data of all the patient's allergies. Other fields 64 are also present, and may include fields devoted to significant events, health issues, care providers and others. The name of the categories in the electronic patient record, and the number of categories is not particularly important and may vary depending on the environment and the choices made by a system administrator.

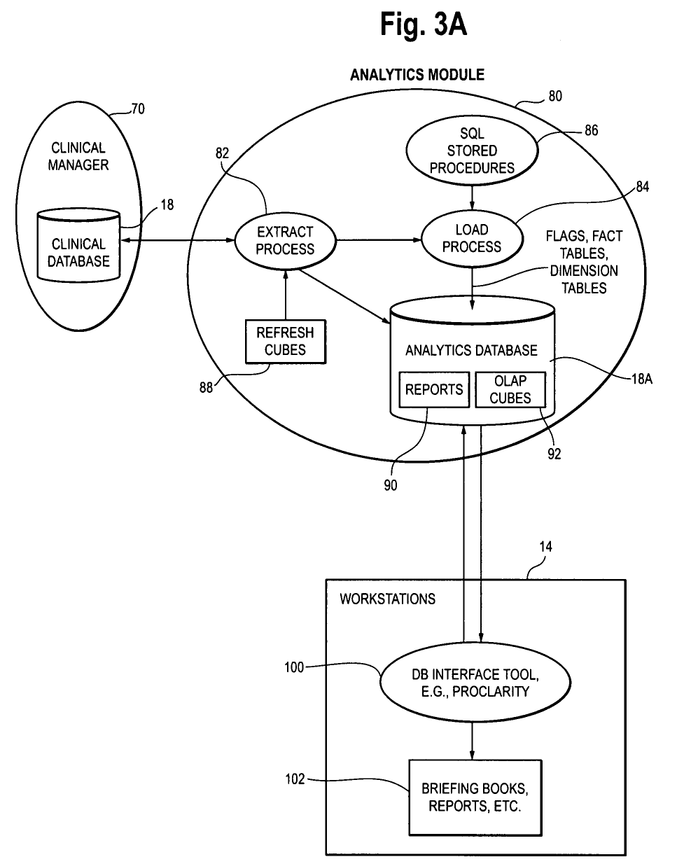

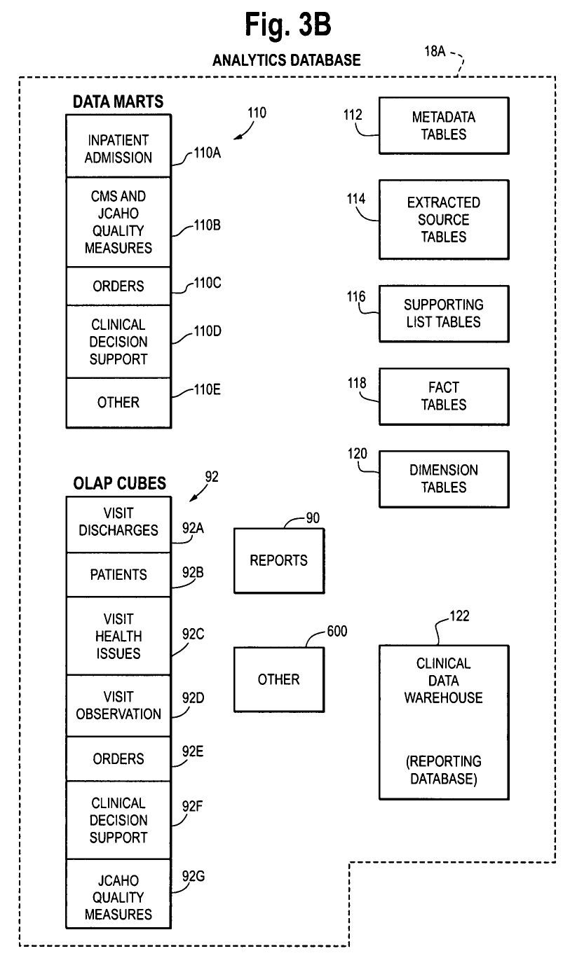

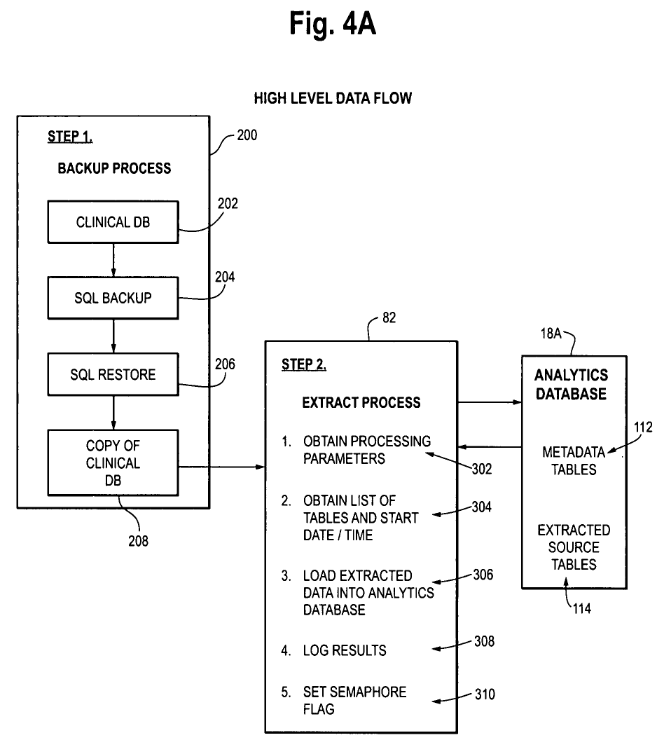

Analytics Module 80 (FIGS. 3A, 3B, 4A and 4B)

In one aspect of this disclosure, a medical records information apparatus is provided which facilitates analysis of clinical data (e.g., patient or patient care information) stored in the clinical database 18 (FIG. 1). The apparatus is in the form of a software application referred to herein as an analytics module 80 (FIG. 3A) which takes of the form of a set of machine readable code (software modules or processes) stored on a machine readable medium, e.g., hard disk or portable medium such as CD, and executable on a computing platform, such as one of the workstations of FIG. 1 or the database server 16 of FIG. 1. The analytics module 80 is designed for use in conjunction with a clinical database 18 storing patient data. In one possible embodiment, the analytics module 80 is offered as an add-on or enhancement with a preexisting medical records management system such as the clinical manager 70 of FIG. 3A.

In particular, the application includes a process 82 extracting clinical data from the clinical database 18 and loading the extracted data into an analytics database 18A shown in FIG. 1. The analytics database 18A is separate from the clinical database 18. A separate analytics database 18A is used in order such that use of the analytics database 18A (e.g., by hospital medial personnel or administrators) does not adversely impact the ongoing use and updating of the clinical database 18, e.g., slowing down access to it by the users operating the workstations 14 of FIG. 1. The load process 84 configures the analytics database 18A in accordance with a data model that is optimized for business intelligence reporting tools, such as commercially available software reporting applications such as PROCLARITY™, e.g., in the form of multidimensional data cubes. The business intelligence reporting tools present the data to the user in known fashion, e.g., using what are known as briefing books, reports, spreadsheets, or other similar methods. The application further includes procedures 86 (e.g., SQL procedures) for applying clinically related logical rules to the clinical data and storing flags associated with the logical rules in the analytics database, i.e., in the fact tables. The structure of the procedures may take a variety of forms, including so-called stored procedures or other format, the details of which are not particularly important and can vary.

The main elements of the analytics module 80 is shown in FIG. 3A, along with its relation to other elements of the system of FIG. 1. The system 10 of FIG. 1 includes a general medical records application 70 which maintains and updates the clinical database 18, referred to as a Clinical Manager in FIG. 3A. An example of the Clinical Manager application is the Sunrise Clinical Manager (SCM) of the assignee Eclipsys Corporation. Other similar and competitive products are commercially available from others in the industry and can be used for the general medial records application or Clinical Manager 70.

The analytics module 80 includes an extract process 82 which operates to extract clinically relevant information from the clinical database 18. The analytics module 80 further includes a load process 84 which loads data, including the flags discussed herein, into the analytics database 18A in a format or configuration optimized for business intelligence reporting tools. The analytics module 80 further includes stored SQL procedures 86 which include procedures in the form of logic statements or rules which are applied to extracted clinical data and are used to set flags of 0 or 1 for user-defined events in the episode of patient care. Other procedures 86 will be identified below. The load process 84 loads the data extracted from the clinical database into the analytics database 18A in the form of fact tables and dimension tables, as explained in further detail below. The analytics database (shown in more detail in FIG. 3B) also includes reports (collections of data) as specified by users or administrators of the system, and multidimensional OLAP cubes 92, which will also be explained in further detail below.

As indicated by the arrows connecting the workstations 14 and the analytics module 80, the purpose of the analytics module is to facilitate user access and analysis of the clinical information in the analytics database 19. Thus, the workstations include a business intelligence tool (software) 100 which interfaces with the analytics database 18A and provides to the user the information the user desires, in the form of briefing books, reports or other format 102 supported by the business intelligence software 100. The reports and briefing books can be presented on the display of the workstation, printed out, assimilated into other documents, etc. in known fashion.

FIG. 3B is a high level schematic view of the analytics database 18A. The process by which the elements of the database 18A are created will be discussed in conjunction with FIG. 4. The database include a plurality of data marts 110, including an inpatient admission datamart 110A, a quality measures datamart 110B, an orders datamart 110C, a clinical decision support datamart 110D, a medical logic module (MLM) datamart 110E, and possibly other data marts.

The inpatient admission datamart 110A contains a subset of the clinical data relating to inpatient admissions. When a visit is created with a visit type of “Inpatient” it means that the patient is admitted to the hospital with the standard definition of an inpatient according to CMS rules. The quality measures created by CMS apply to that visit type. The visit usually lasts greater than 24 hours and generally for several days. There are other visit types that are not inpatient, such as emergency department and ambulatory. These visit types may be open for several hours but usually less than 24 hours. The patient information in these visit types are not extracted into the inpatient admission datamart.

The quality measures datamart 110B basically contains a subset of the clinical data relating to performance of the hospital and its employees relating to quality measures such required by the Joint Commission on Accreditation of Hospitals (JCAHO), standards of the Centers for Medicare and Medicaid (CMS) for management of patients in Medicare and Medicaid programs, and/or health care standards mandated by health insurance companies, employers, or other payers of health care. The focus is on quality measure reporting for the in-patient. Examples of the data in the quality measures datamart 110B could include: identification of patients with named conditions by reviewing authorities, report elements relating to orders, analysis of clinical decision support, medication administration timing in relations to ED admission and or hospital admission, elements of nursing care and education, analysis of standard JCAHO quality related measures, elements contained in orders and documentation, and Prescriptions, in-hospital immunization standards, length of stay, chronic disease profile, adverse metabolic events, discharge location, drug usage patterns, falls, decubitii related information, in-hospital fractures or other injuries, and code related information.

The orders datamart 110C contains a subset of the data relating to orders given to patients. All orders created for an inpatient admission are extracted into the Orders datamart. This data mart includes the essential information that defines the order such as name, type, and priority, timing, order clinician and in the case of medication orders, additional information about dose, units, frequency. The ordering pattern of clinicians and outcomes such as transfers to critical care, discharged alive and length of stay by principle diagnosis can be evaluated.

The clinical decision support datamart 110D contains all of the safety messages that are created for a patient, many of which pop up on the workstation display to the user. The user response to the patient safety alert messages is captured. The average response of the clinicians to these alerts can be measured and compared. The usefulness of these alerts can be measured. The information in the clinical decision datamart 110 contains the data captured by the medical logic modules (MLM) running in the clinical manager application.

The database 18A further includes a plurality of multidimensional OLAP cubes 92, including a visit discharges cube 92A, a patients cube 92B, a visit health issues cube 92C, a visit observations cube 92D, an orders cube 92E, clinical decision support cube 92F, and a quality measures cube 92G. Additional OLAP cubes may also be created and stored within the analytics database. The OLAP cubes 92 are described greater detail below. The OLAP cubes are created from the fact tables by a database application such as Microsoft SQL Server 2000 Analysis Services and serve to organize or arrange the data in a format compatible with the business intelligence reporting tool (100, FIG. 3A) that provides reports to uses of the system.

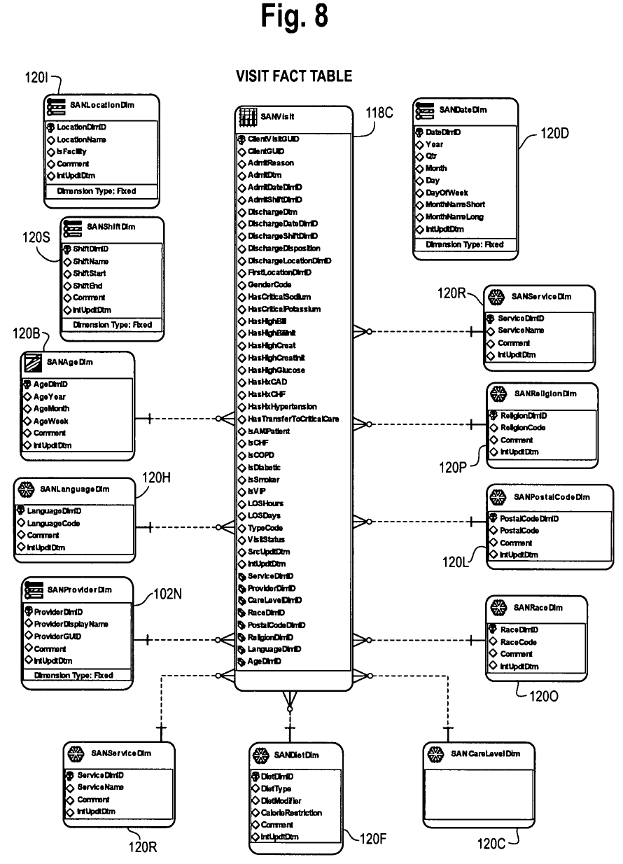

The database 18A includes metadata tables 112. The metadata tables 112 are described in further detail below in conjunction with FIG. 9.

The database 18A further includes extracted source tables 114. These tables are described below in conjunction with the explanation of FIG. 4 and the creation of the database.

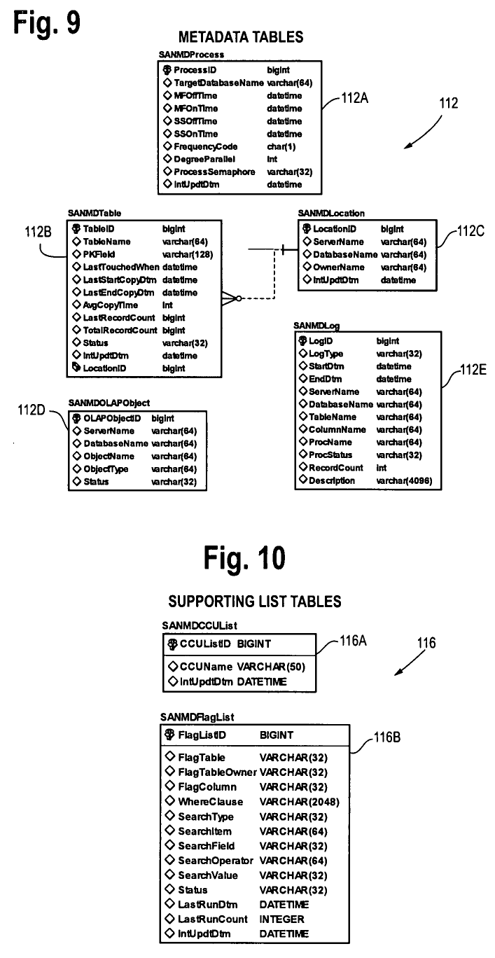

The database 18A further includes supporting list tables 116. These tables are described in further detail below in conjunction with FIG. 10.

The database 18A further includes “fact tables” 118, which are described below in conjunction with FIG. 5-8. In essence, the fact tables store elements of clinical data extracted from the clinical database, flags set by the SQL procedures (86, FIG. 3A), and pointers to dimension tables 120 or other fact tables.

The database 18A further includes dimension tables 120. The dimension tables are shown in FIGS. 5-8 and are described in further detail below. In essence, these tables stored time-related clinical data from the clinical database.

The database 18A further includes a clinical data warehouse 122 providing a reporting database for use in generation of reports.

The database further includes one or more reports 90. The reports 90 (FIGS. 3A and 3B) stored in the database 18A can be specified in advance by the system administrator or customized by the user of the analytics module. Examples of the reports are listed below in Appendix 1.

Creation of Analytics Database 18A

The process of creating the analytics database 18A of FIGS. 1 and 3B will be described with reference to the high level data flow diagram of FIGS. 4A and 4B. These Figures show a backup process (step 1) 200, the extract process 82 (step 2), and a load process 84 (step 3). The processes 200, 82, and 84 are coded as software modules which are part of the analytics module 80 of FIG. 3A.

The process backup process 200 is shown as consisting of four sub-steps 202, 204, 206 and 208. In essence, in this process 202 a backup of the clinical database 18 is created and restored on a server 16 in the computer system 10 of FIG. 1. The restored copy serves as the source database for the extract process 82 (FIGS. 3A, 4A). At step 202, the clinical database 18 is accessed. At step 204, a SQL backup process executes which creates the backup copy of the database and at step 206 the backup is restored on the server 16. At step 208, the copy of the database restored at step 206 is made available to the extract process 82.

The extract process 82 consists of substeps 302, 304, 306, 308 and 310 shown in FIG. 4A. Basically, this process 82 is a C# program the runs as a service on the server 16 of FIG. 1. At step 302, the process reads a table SAMMDProcess to obtain processing parameters. At step 302, the process reads the table SANMDTables to obtain the list of tables to extract from the copy of the database (208) and a starting date/time to use querying the transactions in the clinical database via the date and time stamps applied to each record when it is created or updated. At step 306, the process loads the extracted data into an image of the source table in the analytics database 18A. For example, data in a Visit table extracted from the clinical database 18 is created in the analytics database with the subset of data since the last extract process executed. At step 306, the results of the executed process are logged. At step 308, the process sets a semaphore flag to indicate that data has been extracted and is ready for loading. The flag prevents the extraction of the next set of data until the previous set of data has been loaded into the analytics database.

The result of extract process is shown on the right hand side of FIG. 4A, and consists of the creation of metadata tables 112 (FIG. 9) and the extracted source tables 114 in the analytics database 18A.

FIG. 4B shows the operation of the load process 84. The overall function of the load process is to move incoming data from the extracted source tables 114 into the fact tables 118 (FIGS. 3B, 5-8), populate the dimension tables 120 (FIGS. 3B, 5-8) and set the clinically relevant flags which are stored in the fact tables. As indicated at 402, the load process 84 is carried out using the SQL procedures 86 of FIG. 3A. The result of the load process is the storage in the analytics database 18A of the following fact tables 118: Visit, Order, Clinical Decision Support, Cardionote, and possibly others. The elements of the fact tables 118 are shown in more detail in FIGS. 5-8. Similarly, the result of the load process is the storage in the analytics database 18A of the dimension tables shown in FIGS. 5-8, including the activity status dimension table, age dimension table, etc. The dimension and fact tables are discussed in more detail in the following sections. The flags are stored in the fact tables and/or dimension tables.

Updating Analytics Database 18A

As noted previously, the analytics database 18A is created from the clinical database 18 and the clinical database is constantly being updated by the clinical manager application in real time as new patients are admitted, new orders or test results are entered into the database, etc. There is therefore a need to update the analytics database 18A on an ongoing basis. Therefore, the process of FIGS. 4A and 4B can be performed on a periodic basis, e.g., daily, weekly or on some other basis. As shown in FIG. 3A, a module 88 (“refresh cubes”) invokes the extract process to generate a new edition of the analytics database 18A. In one possible embodiment, when the extract process iterates a second or subsequent time, only new information or information that has changed in the clinical database is extracted and loaded into the analytics database. This simplifies the process of updating the fact and dimension tables and the creation of new, up-to-date OLAP cubes for use by the reporting tools 100.

Analytics Database Tables (FIGS. 3B, 4B, 5-9)

The analytics database 18A stores extracted information from the clinical database 18 in two types of tables, “fact tables” 118 (FIG. 3B) and “dimension tables” 120 (FIG. 3B)

Fact tables are tables of measurements, such as outcomes of tests, and dimension tables are tables of values of variables. Sometimes the same information may be a measurement in a fact table whereas it may be a dimension in another context. A typical dimension is the time or day, or hospital location, in which a particular event is being measured. The time dimension may be a time such as 10:30 am, or it may be an identification of one of the three work shifts such as 7 am-3 pm, 3 pm-11 pm and 11 pm-7 am. The fact of measurement may be an absolute value, such as blood pressure measurement, or it may be a flag that is set as described above. For example, a flag may be set indicating that less than 4 hours elapsed from the time of a medication order until the time of the first administration.

As an example of a fact in a fact table: The patient was given aspirin within 24 hours of admission to the hospital (a flag indicating it did or did not happen). The dimension related to this fact is the variable Principal Diagnosis for admission. In the fact table would be a measurement for the Principle diagnosis of dimension of acute myocardial infarction. As another example, the dimension may be the names of the admitting physicians, and the fact of the aspirin administration within 24 hours can be measured against the dimension of the attending physicians.

As another example of a fact: The measurement is eye examination within the past year (a flag indicating yes or no). The dimension is diagnosis of diabetes (another yes or no flag). Additional dimensions might include the age, race, gender and primary language of the patient.

As another example of a fact: a flag indicating whether or not the patient has had a hemoglobin A1c of >7.5 at any time in the past 12 months. The dimensions may be the flag for a diagnosis of diabetes and the primary care provider.

Dimensions are known variables that might change the number of times that a measurement is true or false or below or above a particular number or was or was not performed. For example, the question may be asked of the system as to how many patients were discharged to the hospital with evidence of counseling to discontinue smoking (flag measurement in the fact table) who had a principle diagnosis of acute myocardial infarction (dimension is principle diagnosis), and who had smoked tobacco products within the past one year (dimension is Smoker (a flag for yes or no) and did not die in the hospital stay (a dimension of discharge disposition)). In this case the counseled patients with these criteria is the numerator and the total number of these patients whether counseled or not is the denominator.

As will be appreciated from the above discussion, any given set of data relating to a patient will include data in both the fact tables and the dimension tables. To relate these tables together, the fact tables and dimension tables will include pointers to each other to reference the fields of the tables (e.g., row and column) that identify the facts and dimensions (variables) that, together, comprise the patient information. Hence, as shown in FIG. 5-9, there are pointers indicated by the symbol 115 between the fact and dimension tables to indicate such relationship. Still other pointers may be present between the tables which are not shown in these figures.

Fact Tables 118 (FIGS. 4B, 5-8)

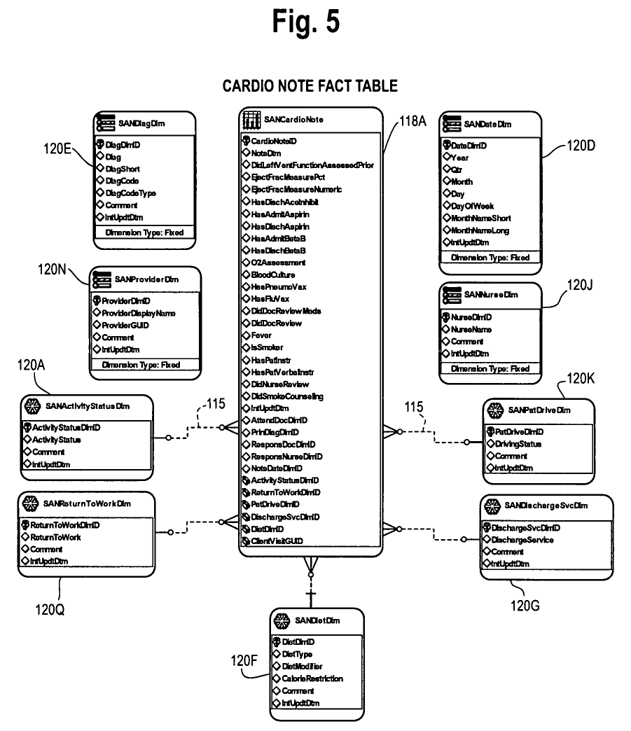

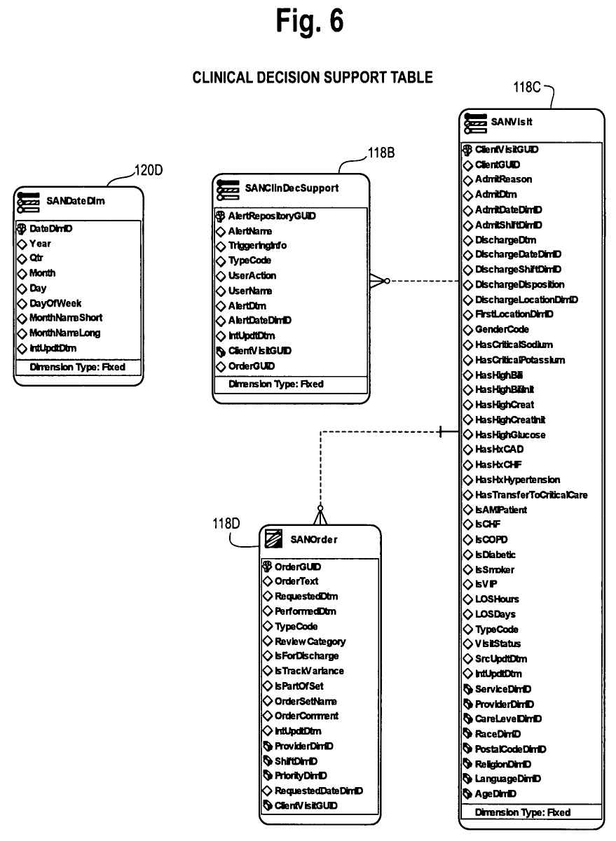

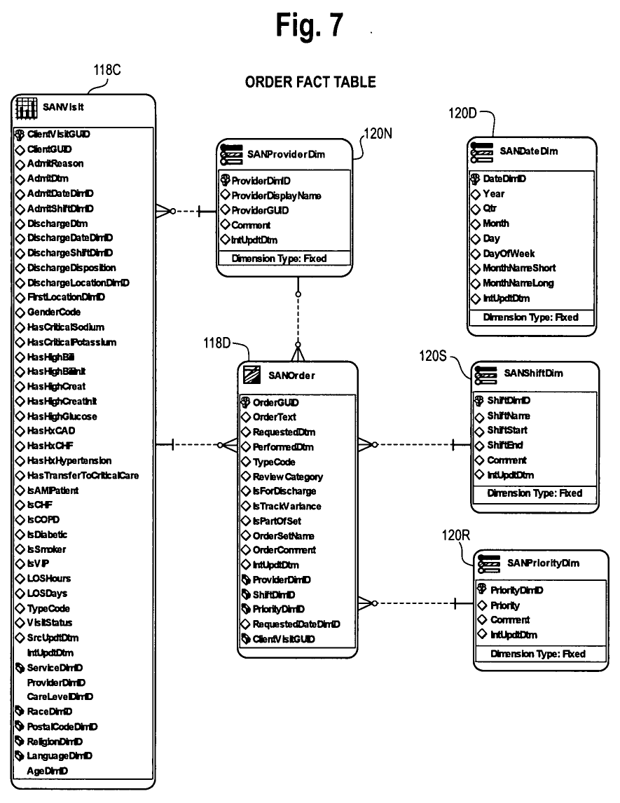

SANCardioNote 118A (FIG. 5)—this fact table is derived from a clinical document that employs a template to collect the answers to questions about possible AMI (cardiac) patients. It further offers JCAHO related data points about care delivered to AMI patients. This fact table provides source data for the “JCAHO Quality Measures” OLAP cube. The entries in the table are listed in FIG. 5. The table also includes pointers (115) to the dimension tables 120 as shown in the Figure.
SANClinDecSupport 118B (FIG. 6)—this fact table derived from MLM (Medical Logic Modules) and Alert data extracted from the clinical database. This fact table supports the “Clinical Decision Support” OLAP cube. This fact table also includes pointers to the Visit and Order fact tables 118C and 118D as shown in FIG. 6. The medical logic modules are small software program that runs inside of the clinical manager application 70 (FIG. 3A) similar to the way that JavaScript runs on a browser. The language for this script is Arden Syntax. This language was developed for the medical chart environment. When medications are prescribed these small computer programs examine the order and looks for allergies to the ordered medication, drug interactions to existing ordered drugs and abnormal lab values which might cause this medication to injure the patient. If the MLM finds a potential danger, a message pops up to the ordering clinician. The clinician can ignore the message and proceed, heed the message and modify the order such as reduce the dose or heed the message and cancel the ordering process.
SANOrder 118D (FIG. 7)—this table is derived from extracted order data from the clinical database for the same inpatient discharged visits found in the SANVisit table (see below). The Order fact table 118D supports the “Order” OLAP cube.
SANVisit 118C (FIG. 8)—this table is derived from the inpatient discharged visit data extracted from the clinical database. This fact table supports two OLPA cubes: “Visit” and “Visit Patients”. As an example of the storage of the flags, the elements of the SANVisit fact table 118C “Has Critical Potassium” would contain a 1 or a 0, depending on the result of application of a logical statement to the extracted data from the clinical database relating to potassium level measurements of a given patient.

Dimension Tables 120

The dimension tables 120 of FIG. 3B are shown in FIGS. 5-8 and are described further below.

SANActivityStatusDim 120A—this table list of possible discharge instructions given to patients regarding their options for strenuous activity. This dimension table is used with the SANCardioNote table to construct the “JCAHO Quality Measures” OLAP cube.

SANAgeDim 120B—list of ages used in reporting. Age can be represented as a year, as a month (as in 23 months old) or both. This table is used with the SANVisit table to construct the two Visit OLAP cubes. SANAgeRangeSet—defines various “sets” or age range categories. Examples include the default “Decile” set which groups ages by decades. SANAgeRangeItem—defines the groupings of ages for the various sets. SANAgeRangePart—defines the relationship between the age range items defined in the SANAgeRangeItem table and the ages recorded in the SANAgeDim table. It associates the individual ages recorded in SANAgeDim with the item groupings defined in the SANAgeRangeItem table.

SANCareLevelDim 120C—defines the departments or areas of care in the facility. This table is used with the SANVisit table to construct the two Visit OLAP cubes.

SANDateDim 120D—defines a calendar of days over a period of years. This table is used by all the fact tables and in the construction of all cubes. The dates start with Jan. 1, 1980 through Dec. 31, 2020 plus 1 row as a default for any dates encountered outside this time 40 year period.

SANDiagDim 120E—list of diagnosis codes used with the SANVisit table to construct the two Visit OLAP cubes.

SANDietDim 120F—a list of dietary categories assigned to patients. This table is used with the SANCardioNote table to construct the “JCAHO Quality Measures” OLAP cube.

SANDischargeSvcDim 120G—list of discharge services performed by the facility. This table is used with the SANCardioNote table to construct the “JCAHO Quality Measures” OLAP cube.

SANLanguageDim 120H—list of languages spoken by patients. This table is used with the SANVisit table to construct the two Visit OLAP cubes.

SANLocationDim 120I—list of locations in the facility. This table is used with the SANVisit table to construct the two Visit OLAP cubes.

SANNurseDim 120J—list of nurses delivering care at the facility. This table is used with the SANCardioNote table to construct the “JCAHO Quality Measures” OLAP cube.

SANPatDriveDim 120K—list of instructions for patients with regard to their driving of automobiles after discharge. This table is used with the SANCardioNote table to construct the “JCAHO Quality Measures” OLAP cube.

SANPostalCodeDim 120L—list of postal zip codes identifying where patients live. This table is used with the SANVisit table to construct the two Visit OLAP cubes.

SANPriorityDim 120M—list of order priorities used by the facility. This table is used with the SANOrder table to construct the Order OLAP cubes.

SANProviderDim 120N—is the list of provider practicing at the facility. This table is used by all the fact tables and in the construction of all cubes.

SANRaceDim 120O—list of patient racial characteristics. This table is used with the SANVisit table to construct the SAN Visit Patients cube.

SANReligionDim 120P—list of patient religious affiliations. This table is used with the SANVisit table to construct the SAN Visit Patients cube.

SANReturnToWorkDim 120Q—list of instructions for patients with regard to their return to work after discharge. This table is used with the SANCardioNote table to construct the “JCAHO Quality Measures” OLAP cube.

SANServiceDim 120R—list of the service categories defined by the facility. This table is used with the SANVisit table to construct the “SAN Visit Discharge” OLAP cubes.

SANShiftDim 120S—lists the work shifts defined by the facility. This table is used with both the SANVisit and SANOrder tables to construct the “SAN Visit” and “SAN Orders” OLAP cubes.
i) SANShiftSet—defines various “sets” or options for establishing work shifts. Examples include the default 8 hour shifts starting at 7:00 A.M. The client would establish different sets such as 8 hours shifts starting at 9:00 A.M. or 4 hours shifts, etc.
ii) SANShiftItem—defines the details of each shift set found in SANShiftSet. For example, the “Default” shift would have one row for 7:00 A.M. to 3:00 P.M., one row for 3:00 P.M. to 10:00 P.M. and a third row for third shift.
iii) SANShiftPart—defines the relationship between the shifts defined in the SANShiftItem table and the shifts recorded in the SANShiftDim table. It associates the individual hours recorded in SANShiftDim with the item groupings defined in the SANShiftItem table.

Metadata Tables 112 (FIG. 9)

SANMDProcess 112A—a single row table of parameters for the clinical database extract process. It contains the parameters that define when to run the extract, the name of the server 16 and the clinical database 18A and the name of the Analytics database 18A. This is also the location of the semaphore flag which is used to prevent the data extraction service from processing a table that is being used by the data population process.

SANMDTable 112B—the list of the clinical database tables from which data is extracted and facts related to the last extract of data from the given table.

SANMDLocation 112C—the name of the clinical database and the server where it can be found.

SANMDOLAPObject 112D—the list of dimensions and cubes that are to be processed with each update of the SAN database. The load process includes a procedure that executes two SQL Server Data Transformation Services (DTS) scripts to refresh the dimensions and then the cubes.

SANMDLog 112E—Execution history

Supporting List Tables 116 (FIG. 10)

1. SANMDCCUList 116A—list of critical care units in the facility.

2. SANMDFlagList 116B—list of medical attribute flags found in the various fact tables. An example would be the IsDiabetic flag found in the SANVisit table. It is used to indicate whether the patient receiving care during the visit was a diabetic.

OLAP Cubes 92

A database application such as MICROSOFT SQL SERVER 2000 ANALYSIS SERVICES (or other suitable application) is used to create and update the following OLAP cubes 92 (FIG. 3B) from the data in the fact and dimension tables outlined on the previous pages and in FIGS. 5-9. For each cube, this document will describe the content in the cube, identify the fact table in the analytics database use as the input source, list the dimensions used to slice and categorize the data, and list the measures that are summarized and counted.

1. SAN Visit Discharges 92A
Description: This cube organizes the inpatient discharges data that describes the admission and discharge facts about the visits.
Source Fact: SANVisit fact table
Dimensions:

| Dimension | Source | Definition |
|---|---|---|
| Admit Date | SANAdmitDateDimVW | Year, Qtr, Month, Day |
| Admit Reason | SANVisit | Admit Reason |
| Admit Shift | SANAdmitShiftDimVW | |
| | SANShiftSet | Shift Set Name |
| | SANShiftItem | Shift Item Name |
| | SANShiftPart | Shift Name |
| Discharge Date | SANDischargeDateDimVW | Year, Qtr, Month, Day |
| Discharge | SANVisit | Discharge Disposition |
| Disposition | | |
| Discharge | SANDischargeLocationDimVW | Discharge Location |
| Location | | Name |
| Discharge Shift | SANAdmitShiftDimVW | |
| | SANShiftSet | Shift Set Name |
| | SANShiftItem | Shift Item Name |
| | SANShiftPart | Shift Name |
| First Location | SANFirstLocationDimVW | First Location Name |
| Provider | SANProviderDim | Provider Display |
| | | Name |

Measures:

| Measure | Type | Definition |
|---|---|---|
| LOS Hours | Sum | [SANVisit].[LOSHours] |
| LOS Days | Sum | [SANVisit].[LOSDays] |
| Avg LOS in Hours | Calculated | [LOS in |
| | | Hours]/[LOSHours Count] |
| Avg LOS in Days | Calculated | [LOS in Days]/[LOSDays |
| | | Count] |
| Visits | Count | [SANVisit].[ClientVisitGUID] |
| Patients | Distinct | [SANVisit].[ClientGUID] |
| | Count | |
| Is Smoker | Sum | [SANVisit].[IsSmoker] |
| Is Diabetic | Sum | [SANVisit].[IsDiabetic] |
| Is VIP | Sum | [SANVisit].[IsVIP] |
| Has Critical Sodium | Sum | [SANVisit].[HasCriticalSodium] |
| Has Critical Potassium | Sum | [SANVisit].[HasCriticalPotassium] |
| Has High Creat | Sum | [SANVisit].[HasHighCreatinine] |
| Has High Creat Init | Sum | [SANVisit].[HasHighCreat |
| | | Init] |
| Has High Bilirubin | Sum | [SANVisit].[HasHighBili] |
| Has High Bilirubin Init | Sum | [SANVisit].[HasHighBiliInit] |
| Has High Glucose | Sum | [SANVisit].[HasHighGlucose] |
| Is COPD | Sum | [SANVisit].[IsCOPD] |
| Has Hx Chf | Sum | [SANVisit].[HasHxChf] |

2. SAN Visit Patients 92B
Description: This cube organizes the inpatient discharges data that organizes data based on the patient demographics.
Source Fact table: SANVisit
Dimensions:

| Dimension | Source | Definition |
|---|---|---|
| Admit Reason | SANVisit | Admit Reason |
| Age Range | SANAgeDim | Age Dimension |
| | SANAgeRangePart | Age Range Set Name |
| | SANAgeRangeItem | Age Range Name |
| | SANAgeRangeSet | Age Year |
| First Location | SANFirstLocationDimVW | First Location Name |
| Discharge | SANDischargeLocationDimVW | Discharge Location |
| Location | | Name |
| Gender | SANVisit | Gender Code |
| Language | SANLanguageDim | Language Code |
| Postal Code | SANPostalCode | Postal codes |
| Provider | SANProviderDim | Provider Display |
| | | Name |
| Race | SANRaceDim | Race Code |
| Religion | SANReligion | Religious |
| | | denomination codes |
| Admit Date | SANVisit | Date and time of |
| | | admission |

Measures:

| Measure | Type | Definition |
|---|---|---|
| LOS Hours | Sum | [SANVisit].[LOSHours] |
| LOS Days | Sum | [SANVisit].[LOSDays] |
| Avg LOS in Hours | Calculated | [LOS in |
| | | Hours]/[LOSHours |
| | | Count] |
| Avg LOS in Days | Calculated | [LOS in |
| | | Days]/[LOSDays Count] |
| Visits | Count | [SANVisit].[ClientVisitGUID] |
| Patients | Distinct | [SANVisit].[ClientGUID] |
| | Count | |
| Is Smoker | Sum | [SANVisit].[IsSmoker] |
| Is Diabetic | Sum | [SANVisit].[IsDiabetic] |
| Is VIP | Sum | [SANVisit].[IsVIP] |
| Has Critical Sodium | Sum | [SANVisit].[HasCriticalSodium] |
| Has Critical Potassium | Sum | [SANVisit].[HasCriticalPotassium] |
| Has High Creat | Sum | [SANVisit].[HasHighCreat] |
| Has High Creat Init | Sum | [SANVisit].[HasHighCreatInit] |
| Has High Bilirubin | Sum | [SANVisit].[HasHighBili] |
| Has High Bilirubin Init | Sum | [SANVisit].[HasHighBiliInit] |
| Has High Glucose | Sum | [SANVisit].[HasHighGlucose] |
| Is COPD | Sum | [SANVisit].[IsCOPD] |
| Has Hx Chf | Sum | [SANVisit].[HasHxChf] |

3. SAN Visit Health Issue 92C
Description: This cube organizes the inpatient discharges data to categorize patients by health issues as defined via dimensions.
Source Fact table: SANVisit
Dimensions:

| Dimension | Source | Definition |
|---|---|---|
| Admit Reason | SANVisit | Admit Reason |
| Age Range | SANAgeDim | Age Dimension |
| | SANAgeRangePart | Age Range Set Name |
| | SANAgeRangeItem | Age Range Name |
| | SANAgeRangeSet | Age Year |
| COPD | SANCOPDDimVW | Is COPD |
| Diabetic | SANDiabeticDimVW | Is Diabetic |
| Gender | SANVisit | Gender |
| Hx CHF | SANHxCHFDimVW | Has Hx CHF |
| High Glucose | SANHighGlucoseDimVW | Has High Glucose |
| Smoker | SANSmokerDimVW | Is Smoker |
| Provider | SANProviderDim | Provider Display Name |
| VIP | SANVIPDimVW | Is VIP |

Measures:

| Measure | Type | Definition |
|---|---|---|
| LOS Hours | Sum | [SANVisit].[LOSHours] |
| LOS Days | Sum | [SANVisit].[LOSDays] |
| Avg LOS in Hours | Calculated | [LOS in |
| | | Hours]/[LOSHours |
| | | Count] |
| Avg LOS in Days | Calculated | [LOS in |
| | | Days]/[LOSDays |
| | | Count] |
| Visits | Count | [SANVisit].[ClientVisitGUID] |
| Patients | Distinct Count | [SANVisit].[ClientGUID] |

4. SAN Visit Observation 92D
Description: This cube organizes the inpatient discharges data to categorize patients by observations recorded during the visits as defined via dimensions.
Source Fact: SANVisit
Dimensions:

| Dimension | Source | Definition |
|---|---|---|
| Admit Reason | SANVisit | Admit Reason |
| Age Range | SANAgeDim | Age Dimension |
| | SANAgeRangePart | Age Range |
| | | Set Name |
| | SANAgeRangeItem | Age Range Name |
| | SANAgeRangeSet | Age Year |
| Critical Potassium | SANCriticalPotassiumDimVW | Has Critical |
| | | Potassium |
| Critical Sodium | SANCriticalSodiumDimVW | Has Critical Sodium |
| Gender | SANVisit | Gender |
| High Bilirubin | SANHighBiliDimVW | Has High Bilirubin |
| | | level |
| High Initial | SANHighBiliInitFlag | Has High Initial |
| Bilirubin | | Bilirubin level |
| High Creatinine | SANHighCreatDimVW | Has High Creatinine |
| | | level |
| High Initial | SANHighCreatInitDimVW | Has High Initial |
| Creatinine | | Creatinine level |
| Provider | SANProviderDim | Provider Display |
| | | Name |

Measures:

| Measure | Type | Definition |
|---|---|---|
| LOS Hours | Sum | [SANVisit].[LOSHours] |
| LOS Days | Sum | [SANVisit].[LOSDays] |
| Avg LOS in Hours | Calculated | [LOS in |
| | | Hours]/[LOSHours |
| | | Count] |
| Avg LOS in Days | Calculated | [LOS in |
| | | Days]/[LOSDays |
| | | Count] |
| Visits | Count | [SANVisit].[ClientVisitGUID] |
| Patients | Distinct Count | [SANVisit].[ClientGUID] |

5. SAN Order 92E
Description: This cube organizes the order data for the same inpatient discharges.
Source Fact: SANOrder
Dimensions:

| Age Dimension | Source | Definition |
|---|---|---|
| Priority | SANPriorityDim | Priority |
| Provider | SANProviderDim | Provider Display |
| | | Name |
| Shift | SANShiftDim | Shift Dimension |
| | SANShiftPart | Shift Set Name |
| | SANShiftItem | Shift Item Name |
| | SANShiftSet | Shift Name |
| OrderSetName | SANOrder | Order Set name and |
| | | Order Text |
| Date Requested | SANOrder | Order requested date |
| | | and time |
| Date Performed | SANOrder | Order performed date |
| | | and time |

Measures:

| Age Dimension | Type | Definition |
|---|---|---|
| Orders | Count | [SANOrder].OrderGUID |
| Visits | Distinct Count | [SANOrder].ClientVisitGUID |
| Is For Discharge | Sum | [SANOrder].IsForDischarge |
| Is Part Of Set | Sum | [SANOrder].IsPartOfSet |

6. Clinical Decision Support 92F
Description: This cube organizes the Alert MLM data for the inpatient discharges.
Source Fact table: SANClinDecSupport
Dimensions:

| Age Dimension | Source | Definition |
|---|---|---|
| MLM Name | SANClinDecSupport | Name |
| Triggers | SANClinDecSupport | Triggering |
| | | Information |
| Type Code | SANClinDecSupport | Type Code |
| User Action | SANClinDecSupport | User Action |
| User Name | SANClinDecSupport | User Name |
| Alert Date | SANClinDecSupport | Date and time the |
| | | alert was triggered |

Measures:

| Age | | |
|---|---|---|
| Dimension | Type | Definition |
| Alerts | Count | [SANClinDecSupport].AlertRepositoryGUID |
| Visits | Distinct Count | [SANClinDecSupport].ClientVisitGUID |

7. JCAHO Quality Measures 92G
Description: This cube organizes the JCAHO AMI measure data collected via the cardio note document template developed by a client.
Source Fact table: SANCardioNote
Dimensions:

| Age Dimension | Source | Definition |
|---|---|---|
| Activity Status | SANActivityStatusDim | Activity Status |
| Diet | SANDietDim | Diet Type |
| Discharge Svc | SANDischargeSvcDim | Discharge Service |
| Eject Fracture Pct | SANCardioNote | Ejection Fraction |
| | | Measure Percentage |
| Fever | SANCardioNote | Fever |
| Nurse | SANNurseDim | Nurse Name |
| Principle Diag | SANDiagDim | Principle Diagnosis |
| | | code |
| Attend Provider | SANProviderDim | Attending Provider's |
| | | Display Name |
| Responsible Provider | SANProviderDim | Responsible |
| | | Provider's Display |
| | | Name |
| Return to Work | SANReturnToWorkDim | Return To Work |

Measures:

| Age Dimension | Type | Definition |
|---|---|---|
| Visits | Count | [SANCardioNote].[ClientVisitGUID] |
| Did Left Vent Function Assessed Prior | Sum | [SANCardioNote].[DidLeftVentFunctionAssessedPrior] |
| Has Disch Ace Inhibit | Sum | [SANCardioNote].[HasDischAceInhibit] |
| Has Admit Aspirin | Sum | [SANCardioNote].[HasAdmitAspirin] |
| Has Disch Aspirin | Sum | [SANCardioNote].[HasDischAspirin] |
| Has Admit Beta B | Sum | [SANCardioNote].[HasAdmitBetaB] |
| Has Disch Beta B | Sum | [SANCardioNote].[HasDischBetaB] |
| Has Pneumo Vax | Sum | [SANCardioNote].[HasPneumoVax] |
| Has Flu Vax | Sum | [SANCardioNote].[HasFluVax] |
| Did Doc Review Meds | Sum | [SANCardioNote].[DidDocReviewMeds] |
| Did Doc Review | Sum | [SANCardioNote].[DidDocReview] |
| Is Smoker | Sum | [SANCardioNote].[IsSmoker] |
| Has Pat Instr | Sum | [SANCardioNote].[HasPatInstr] |
| Has Pat Verbal Instr | Sum | [SANCardioNote].[HasPatVerbalInstr] |
| Did Nurse Review | Sum | [SANCardioNote].[DidNurseReview] |
| Did Smoke Counseling | Sum | [SANCardioNote].[DidSmokeCounseling] |

Reporting Using Business Intelligence Tools

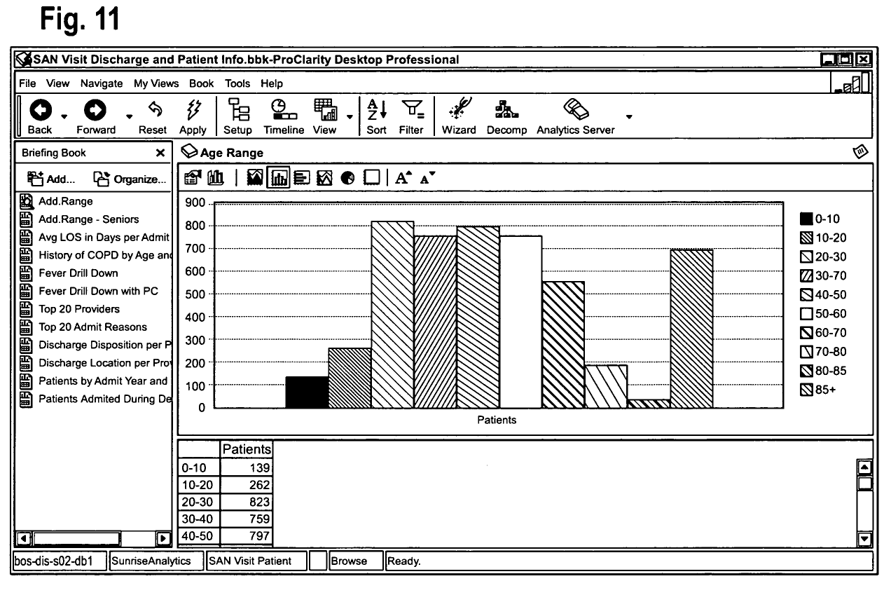

A commercially available business intelligence reporting application such as PROCLARITY™ from Microsoft Corporation is used to create a set of reports, called Briefing Books, that allow users to view the OLAP cube data and to refine the presentation. For each briefing book, a screen shot is shown in the appended Figures which illustrates the list of reports in the frame on the left hand side of the screen, the list of measures and dimensions in the frame on the middle, left hand side of the screen that can be moved into and out of the given report in order to refine presented information, and the presented report in the major frame on the screen. It will be apparent to persons skilled in the art that there are a variety of formats that can be used to display the details of the reports and the screen shots of FIGS. 11-15 are offered by way of illustration and not limitation.

1. Visit Discharge and Patient Information briefing book (FIG. 11)

Cube: SAN Visit Patients

Cube: SAN Visit Discharges

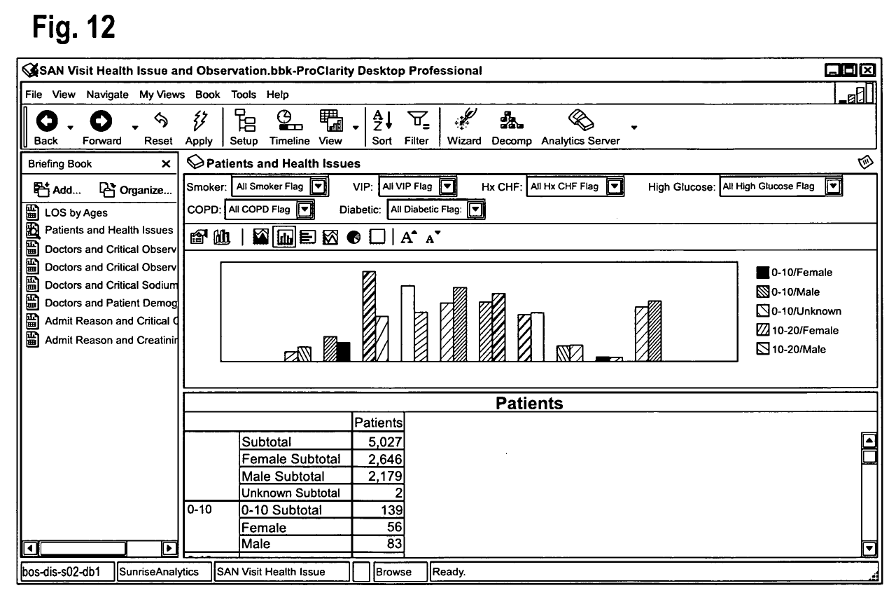

Reports: Discharged Visits by
Age Range
Age Range for seniors
Average Length of Stay in Days per Admit Provider
History of COPD by Age and Gender
Fever Drill Down
Fever Drill Down with PC
Top 20 Providers
Top 20 Admit Reasons
Discharge Disposition per Provider
Discharge Location per Provider
Patients by Admit Year and by Provider
Patients Admitted During Default Shift
   2. SAN Visit Health Issue and Observation briefing book (FIG. 12)

Cube: SAN Visit Health Issue

Cube: SAN Visit Observation

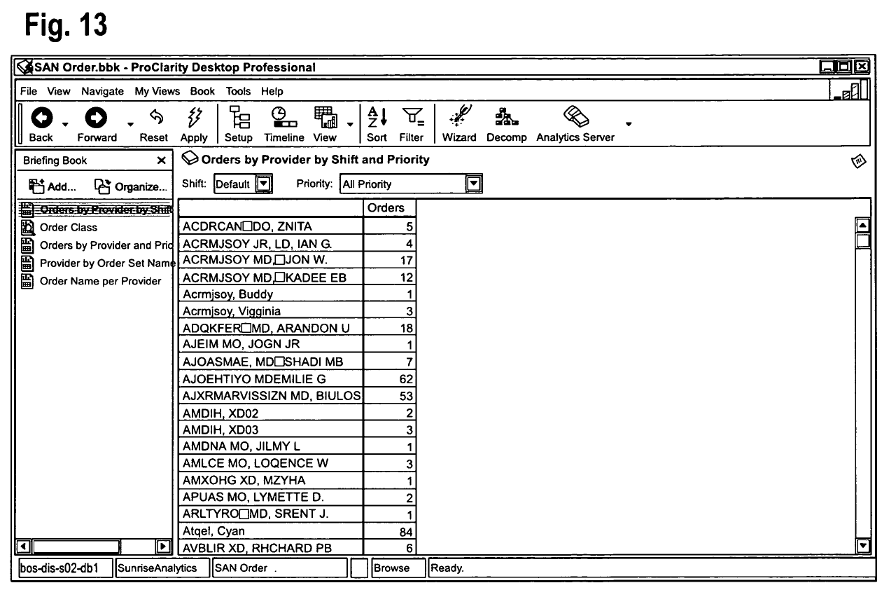

Reports: Discharged Visits by
Length of Stay (LOS) by Ages
Patients and Health Issues
Doctors and Critical Observations
Doctors and Critical Observations—Pneumonia
Doctors and Critical Sodium
Doctors and Patient Demographics
Admit Reason and Critical Observations
Admit Reason and Creatinine
   3. SAN Order briefing book (FIG. 13)

Cube: SAN Order

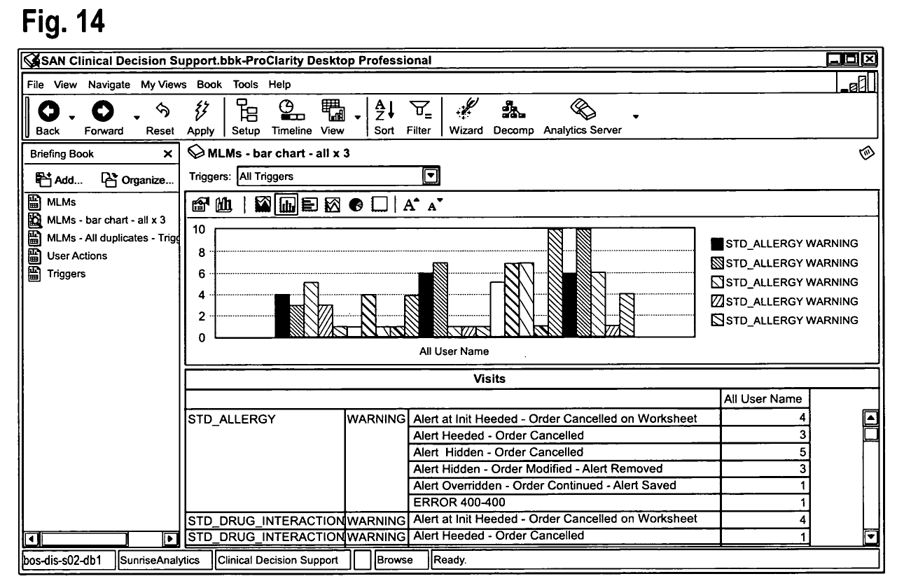

Reports: Orders by
Order by Provider by Shift and Priority
Order Class
Orders by Provider and Priority
Provider by Order Set Name
Order Name per Provider
   4. SAN Clinical Decision Support briefing book (FIG. 14)

Cube: Clinical Decision Support

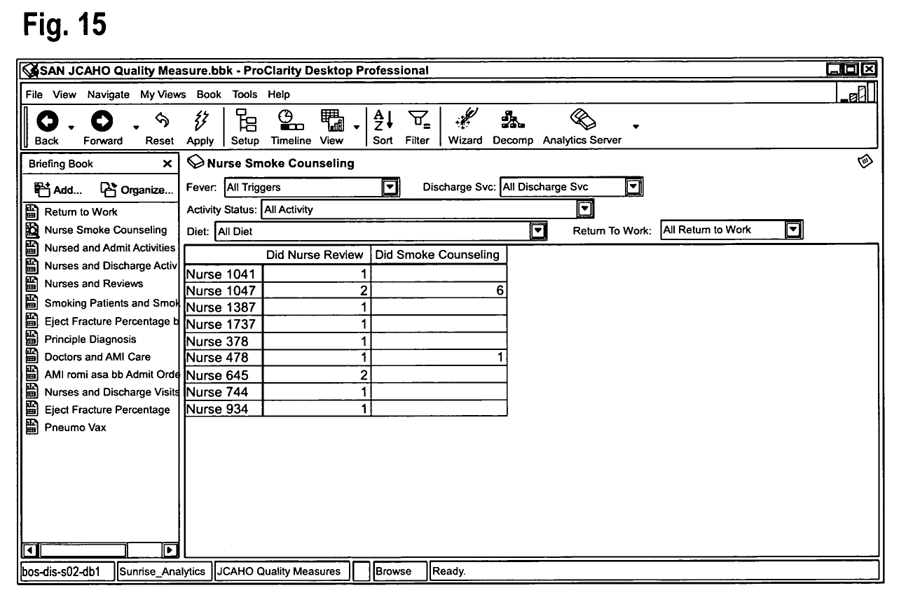

Reports:
MLMs
MLM's Bar Chart
MLMs—All Duplicates by Triggers
User Actions
Triggers
   5. SAN JCAHO Quality Measure briefing book (FIG. 15)

Cube: JCAHO Quality Measure

Reports: Orders by
Return to Work
Nurse Smoke Counseling
Nurses and Admit Activities
Nurses and Discharge Activities
Nurses and Reviews
Smoking Patients and Smoking Counseling
Eject Fracture Percentage by Provider
Principle Diagnosis
Doctors and AMI Care
AMI ROMI as Beta Blocker Admit Order by Provider
Nurses and Discharge Visits
Eject Fracture Percentage with Ace Inhibitors
Pneumonia Vaccinations

Terminology

As used herein, the term “datamart” refers to repository of data which contains a subset of organizational data (in this instance, medical related or clinical data) which helps a health care enterprise to analyze medical related information, e.g., on the basis of past trends and experiences. The creation of a data mart is predicated on a specific, predefined need for a certain grouping and configuration of select data. A data mart configuration emphasizes easy access to relevant information.

The term “OLAP (On-Line Analytical Processing) cube” refers to an array of data into a multidimensional format, referred to as a “cube”. The arrangement of data into cubes avoids a limitation of relational databases which are not well suited for near instantaneous analysis of large amounts of data. Relational databases are better suited for creating records from a series of transactions (known as OLTP or on-line transaction processing). OLAP cubes can be thought of as extensions to the two-dimensional array of a spreadsheet. For example, a hospital might wish to analyze some clinical data by time-period, by doctor, by facility, by type of revenue and cost, and by comparing actual data with some standard. These additional methods or parameters of analysing the data are known as dimensions.

While a number of exemplary aspects and embodiments have been discussed above, those of skill in the art will recognize certain modifications, permutations, additions and sub-combinations thereof may be made to the specifics of the preceding disclosure. It is therefore intended that the following appended claims, and claims hereafter introduced, are interpreted to include all such modifications, permutations, additions and sub-combinations as are within their true spirit and scope.

### Appendix 1

### Reports Stored in Analytics Database

Examples of reports 90 (FIGS. 3A, 3B) include reports which sort by the admitting provider (e.g., physician) compare:
1. # of patients listed as VIP
2. Length of stay in hours/days
3. Admitting Reasons
4. Admitting Shifts
5. Discharge Shifts
6. Discharge Day of Week
7. Discharge Disposition
8. Discharge Location
9. Admitting Reason
10. Patients from Various Zip Codes
11. Number of Admissions by Quarter
12. Number of Admissions by Year
13. Admission by Age distribution
14. Critical Sodium
15. Critical Potassium
16. Patients admitted with creatinine's >2
17. Patients admitted with creatinines <=2 but had creatinines >2 during the admission
18. Patients admitted with Bilirubin's >2
19. Patients admitted with Bilirubin's <=2 but had creatinines >2 during the admission
20. MI during this admission
21. Any diagnosis caused by Coronary Artery Disease ever charted
22. History of Diabetes
23. History of COPD
24. History of CHF
25. Smoker

Other types of reports can include general demographics reports, such as breakdown in the patient population by items such as

1. Gender

2. Race

3. Language

4. Religion

5. Postal Code

6. Age distribution

As another example, the analytics module can create complex reports, such as

Admit Reason and LOS with the variables of Diabetes, COPD, CHF, Smoker, CAD, MI, Probable Kidney Disease, Probable Liver Disease, Admit reason and Admitting Provider.

The analytics module can also prepare reports 90 concerning orders placed, such as for example

1. Orders by Provider

2. Orders by Provider by Priority (Stat, Routine, Now, Time Critical)

3. Provider Orders by Shift

The analytics module can also prepare discharge reports 90, such as reports

1. for acute MI (myocardial infarction) patients:
a. Aspirin on admission
b. Beta Blockers on Admission
c. Aspirin on Discharge
d. Beta Blockers on Discharge
e. If Ejection Fraction <40%—ACE or ARB on discharge
f. If Smoker—Stop smoking counseling
   i. A smoker is defined as smoking within a year of admission
g. Alive at Discharge

2. for Heart Failure Patients
a. ACE or ARB for moderate to severe LVSD
   i. LVSD=left ventricular systolic dysfunction
   ii. LVEF <40%
   iii. LV=Left Ventricular
   iv. EF=Ejection Fraction
   v. F=Function
   vi. SD=Systolic Dysfunction
b. If Smoker—Stop smoking counseling
   i. A smoker is defined as smoking within a year of admission
c. Discharge Instructions
   i. Activity Level
   ii. Diet
   iii. Discharge medication
   iv. Follow up appointments
   v. Weight monitoring
   vi. What to do if symptoms worsen
d. LVEF (Documentation that it was done before admission, during hospitalization or planned after discharge)

3. Community Acquired Pneumonia
a. Oxygenation Assessment
b. Blood Cultures
c. Antismoking Advice
   i. A smoker is defined as smoking within a year of admission
d. Pneumococcal Vaccination
e. Influenza Vaccination
f. Antibiotics within 4 to 8 hours of admission

### Appendix 2

### Clinical Flags Assessed and Stored in the Analytics Database

The table that follows lists the “flags” set during the process of moving data from the clinical database 18 to the analytics database 18A. Some of the flags indicate whether or not a specific event occurred and others whether or not the patient has the medically relevant characteristic. The basic specifications are retained in a table called SANMDFlagList. Its definition is provided below.

| COLUMN | DATATYPE | NULLABLE | DEFAULTS | DESCRIPTION |
|---|---|---|---|---|
| [FlagListID] | [bigint] | NOT NULL | IDENTITY(1,1) | Primary Key |
| [FlagTable] | [varchar](32) | NOT NULL, | | Target table in Sunrise |
| | | | | Clinical Analytics |
| | | | | datatase |
| [FlagTableOwner] | [varchar](32) | NOT NULL | (‘dbo’), | Table dbowner |
| [FlagColumn] | [varchar](32) | NOT NULL, | | Flag column name |
| [WhereClause] | [varchar](2048) | NULL, | | The where clause |
| | | | | criteria |
| [SearchType] | [varchar](32) | NOT NULL, | | Description of the |
| | | | | search type. Valid |
| | | | | values include: |
| | | | | “diagnosis”, “result”, |
| | | | | “lookupHit”, “HistoryDx”, |
| | | | | “firstResult” |
| [SearchItem] | [varchar](64) | NULL, | | Keywords used in the |
| | | | | search of text strings |
| [SearchField] | [varchar](32) | NULL, | | Name of the tag field |
| | | | | linked to the search |
| [SearchOperator] | [varchar](64) | NULL, | | Operator used in |
| | | | | search. Valid values |
| | | | | include: “like”, “=”, “>”, |
| | | | | “<”” |
| [SearchValue] | [varchar](32) | NULL, | | The target search value |
| [Status] | [varchar](32) | NOT NULL, | (‘Y’), | Status code of “Active” |
| | | | | or “Inactive” |
| [LastRunDtm] | [datetime] | NULL, | | Date of last execution |
| [LastRunCount] | [int] | NULL, | | Couint of rows found in |
| | | | | last execution |
| [IntUpdtDtm] | [datetime] | NOT NULL, | (getdate( )), | Date and time the row |
| | | | | was last updated. |

From the SANMDFlagList table the list of flags ([FlagColumn]), the source table ([FlagTable]) and the criteria ([WhereCriteria]) have been extracted and recorded in the next table seen below.

The first column in the table identifies the “flag” that the user will see in the reports. The second column identifies the clinical database tables that provided the relevant data clues. The third column lists the actual criteria that have to be met to set the flag to ‘true’ or ‘positive’. The default is ‘false’ or ‘negative’.

In this table each listed flag is followed by the SQL UPDATE statement that is generated by a SQL Server Stored Procedure that queries the table to construct and submit the UPDATE statement for processing.

| Flag | Table | Criteria |
|---|---|---|
| Has Critical | CV3 BasicObservation | ItemName = |
| Potassium | | ‘Potassium |
| | | Level’ and |
| | | value < 2.8 |

| | |
|---|---|
| The LOGIC: | update SANVisit set HasCriticalPotassium=1 |
| | from SANVisit a |
| | inner join SunriseAnalytics.dbo.CV3BasicObservation bos |
| | on a.ClientVisitGUID=bos.ClientVisitGuid |
| | and bos.ItemName = ‘Potassium Level’ |
| | and .dbo.ReturnNumeric(bos.value) < 2.8 |

| | | |
|---|---|---|
| Has Critical | CV3BasicObservation | ItemName = |
| Sodium | | ‘Sodium’ and |
| | | value < 125 |

| | |
|---|---|
| The LOGIC: | update SANVisit set HasCriticalSodium=1 |
| | from SANVisit a |
| | inner join SunriseAnalytics_FEB.dbo.CV3BasicObservation bos |
| | on a.ClientVisitGUID=bos.ClientVisitGuid |
| | and bos.ItemName = ‘Sodium’ |
| | and .dbo.ReturnNumeric(bos.value) < 125 |

| | | |
|---|---|---|
| Has High Bilirubin | CV3BasicObservation | ItemName |
| | | like |
| | | ‘Bilirubin%’ |
| | | and value > 2 |

| | |
|---|---|
| The LOGIC: | update SANVisit set HasHighBili=1 |
| | from SANVisit a |
| | inner join SunriseAnalytics_FEB.dbo.CV3BasicObservation bos |
| | on a.ClientVisitGUID=bos.ClientVisitGuid |
| | and bos.ItemName like ‘Bilirubin%’ |
| | and .dbo.ReturnNumeric(bos.value) > 2 |

| | | |
|---|---|---|
| Has High Initial Bilirubin | CV3BasicObservation bos, SANFirstLabVW fl | ItemName |
| | WHERE bos.CreatedWhen=fl.MinTimestamp | like |
| | | ‘Bilirubin%’ |
| | | and value > 2 |

| | |
|---|---|
| The LOGIC: | update SANVisit set HasHighBiliInit=1 |
| | from SANVisit a |
| | inner join SunriseAnalytics_FEB.dbo.CV3BasicObservation bos |
| | on a.ClientVisitGUID=bos.ClientVisitGuid |
| | and bos.ItemName like ‘Bilirubin%’ |
| | and .dbo.ReturnNumeric(bos.value) > 2 |
| | inner join SANFirstLabVW fl |
| | on bos.ItemName=fl.ItemName |
| | and bos.ClientVisitGUID=fl.ClientVisitGUID |
| | and bos.CreatedWhen=fl.MinTimestamp |

| | | |
|---|---|---|
| Has High Creatinine | CV3BasicObservation | ItemName = |
| | | ‘Creatinine, |
| | | Serum’ and |
| | | value > 2 |

| | |
|---|---|
| The LOGIC: | update SANVisit set HasHighCreat=1 |
| | from SANVisit a |
| | inner join SunriseAnalytics_FEB.dbo.CV3BasicObservation bos |
| | on a.ClientVisitGUID=bos.ClientVisitGuid |
| | and bos.ItemName = ‘Creatinine, Serum’ |
| | and .dbo.ReturnNumeric(bos.value) > 2 |

| | | |
|---|---|---|
| Has High Initial | CV3BasicObservation bos | ItemName = |
| Creatinine | SANFirstLabVW fl | ‘Creatinine, |
| | WHERE bos.CreatedWhen=fl.MinTimestamp | Serum’ and |
| | | value > 2 |

| | |
|---|---|
| The LOGIC: | update SANVisit set HasHighCreatInit=1 |
| | from SANVisit a |
| | inner join SunriseAnalytics_FEB.dbo.CV3BasicObservation bos |
| | on a.ClientVisitGUID=bos.ClientVisitGuid |
| | and bos.ItemName = ‘Creatinine, Serum’ |
| | and .dbo.ReturnNumeric(bos.value) > 2 |
| | inner join SANFirstLabVW fl |
| | on bos.ItemName=fl.ItemName |
| | and bos.ClientVisitGUID=fl.ClientVisitGUID |
| | and bos.CreatedWhen=fl.MinTimestamp |

| | | |
|---|---|---|
| Has High Glucose | CV3BasicObservation | ItemName = |
| | | ‘Glucose’ and |
| | | value > 200 |

| | |
|---|---|
| The LOGIC: | update SANVisit set HasHighGlucose=1 |
| | from SANVisit a |
| | inner join SunriseAnalytics_FEB.dbo.CV3BasicObservation bos |
| | on a.ClientVisitGUID=bos.ClientVisitGuid |
| | and bos.ItemName = ‘Glucose’ |
| | and .dbo.ReturnNumeric(bos.value) > 200 |

| | | |
|---|---|---|
| Has History of Cardiac | CV3HealthIssueDeclaration hid, | chi.code like |
| Artery Disease | CV3CodedHealthIssue chi | ‘41[0,1,2,3,4] |
| | WHERE hid.CodedHealthIssueGUID=chi.GUID | %’ |

| | |
|---|---|
| The LOGIC: | update SANVisit set HasHxCAD=1 |
| | from SANVisit a |
| | inner join SunriseAnalytics_FEB.dbo.CV3HealthIssueDeclaration hid |
| | on a.ClientGUID=hid.ClientGuid |
| | inner join SunriseAnalytics_FEB.dbo.CV3CodedHealthIssue chi |
| | on hid.CodedHealthIssueGUID=chi.GUID |
| | and chi.code like ‘41[0,1,2,3,4]%’ |

| | | |
|---|---|---|
| Has History of Cardiac | CV3HealthIssueDeclaration hid, | chi.code like |
| Heart Failure | CV3CodedHealthIssue chi | ‘428%’ |
| | WHERE | |
| | hid.CodedHealthIssueGUID=chi.GUID | |

| | |
|---|---|
| The LOGIC: | update SANVisit set HasHxCHF=1 |
| | from SANVisit a |
| | inner join SunriseAnalytics_FEB.dbo.CV3HealthIssueDeclaration hid |
| | on a.ClientGUID=hid.ClientGuid |
| | inner join SunriseAnalytics_FEB.dbo.CV3CodedHealthIssue chi |
| | on hid.CodedHealthIssueGUID=chi.GUID |
| | and chi.code like ‘428%’ |

| | | |
|---|---|---|
| Has Transfer To | cv3ClientVisitLocation cvl, cv3Location loc | List of CCU |
| Critical Care | WHERE cvl.locationGUID=loc.GUID | units in the |
| | and loc.Name in (select CCUName from | hospital |
| | SANMDCCUList) | |

| | |
|---|---|
| The LOGIC: | update SANVisit set HasTransferToCriticalCare=1 |
| | from SANVisit a |
| | where ClientVisitGUID in |
| | (select ClientVisitGUID |
| | from cv3ClientVisitLocation cvl |
| | inner join cv3Location loc |
| | on cvl.locationGUID=loc.GUID |
| | and loc.Name in |
| | (select CCUName from sanMDCCUList)) |

| | | |
|---|---|---|
| IsAMIPatient | CV3HealthIssueDeclaration hid, | chi.code like |
| | CV3CodedHealthIssue chi | ‘410%’ |
| | WHERE | |
| | hid.CodedHealthIssueGUID=chi.GUID | |

| | |
|---|---|
| The LOGIC: | update SANVisit set IsAMIPatient=1 |
| | from SANVisit a |
| | inner join SunriseAnalytics_FEB.dbo.CV3HealthIssueDeclaration hid |
| | on a.ClientVisitGUID=hid.ClientVisitGuid |
| | inner join SunriseAnalytics_FEB.dbo.CV3CodedHealthIssue chi |
| | on hid.CodedHealthIssueGUID=chi.GUID |
| | and chi.code like ‘410%’ |

| | | |
|---|---|---|
| IsCHF | CV3HealthIssueDeclaration hid, | chi.code like |
| | CV3CodedHealthIssue chi | ‘428%’ |
| | WHERE | |
| | hid.CodedHealthIssueGUID=chi.GUID | |

| | |
|---|---|
| The LOGIC: | update SANVisit set IsCHF=1 |
| | from SANVisit a |
| | inner join SunriseAnalytics_FEB.dbo.CV3HealthIssueDeclaration hid |
| | on a.ClientVisitGUID=hid.ClientVisitGuid |
| | inner join SunriseAnalytics_FEB.dbo.CV3CodedHealthIssue chi |
| | on hid.CodedHealthIssueGUID=chi.GUID |
| | and chi.code like ‘428%’ |

| | | |
|---|---|---|
| IsCOPD | CV3HealthIssueDeclaration hid, | chi.code like |
| | CV3CodedHealthIssue chi | ‘49[1,2,3]%’ |
| | WHERE | |
| | hid.CodedHealthIssueGUID=chi.GUID | |

| | |
|---|---|
| The LOGIC: | update SANVisit set IsCOPD=1 |
| | from SANVisit a |
| | inner join SunriseAnalytics_FEB.dbo.CV3HealthIssueDeclaration hid |
| | on a.ClientVisitGUID=hid.ClientVisitGuid |
| | inner join SunriseAnalytics_FEB.dbo.CV3CodedHealthIssue chi |
| | on hid.CodedHealthIssueGUID=chi.GUID |
| | and chi.code like ‘49[1,2,3]%’ |

| | | |
|---|---|---|
| IsDiabetic | CV3HealthIssueDeclaration hid, | chi.code like |
| | CV3CodedHealthIssue chi | ‘250%’ |
| | WHERE | |
| | hid.CodedHealthIssueGUID=chi.GUID | |

| | |
|---|---|
| The LOGIC: | update SANVisit set IsDiabetic=1 |
| | from SANVisit a |
| | inner join SunriseAnalytics_FEB.dbo.CV3HealthIssueDeclaration hid |
| | on a.ClientVisitGUID=hid.ClientVisitGuid |
| | inner join SunriseAnalytics_FEB.dbo.CV3CodedHealthIssue chi |
| | on hid.CodedHealthIssueGUID=chi.GUID |
| | and chi.code like ‘250%’ |

| | | |
|---|---|---|
| IsSmoker | CV3HealthIssueDeclaration hid, | chi.code like |
| | CV3CodedHealthIssue chi | ‘305.1%’ |
| | WHERE hid.CodedHealthIssueGUID=chi. | |
| | GUID | |

| | |
|---|---|
| The LOGIC: | update SANVisit set IsSmoker=1 |
| | from SANVisit a |
| | inner join SunriseAnalytics_FEB.dbo.CV3HealthIssueDeclaration hid |
| | on a.ClientVisitGUID=hid.ClientVisitGuid |
| | inner join SunriseAnalytics_FEB.dbo.CV3CodedHealthIssue chi |
| | on hid.CodedHealthIssueGUID=chi.GUID |
| | and chi.code like ‘305.1%’ |

### Appendix 3

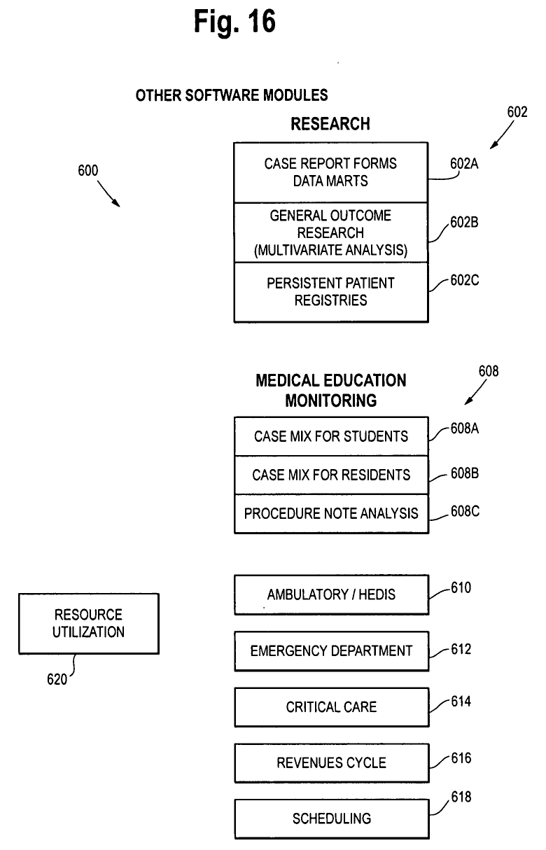

### Other Software Modules (FIG. 16)

It is contemplated that additional software modules can be incorporated into the analytics module 80 and used to generate additional reports or other collections of data.

Research 602

A research module can create case report forms data marts (602A), perform general outcome research (using multivariate analysis) (602B), and reports of persistent patient registries for studies (602C).

The outcomes research module (602B) monitors for adverse events over time for chronic diseases, such as
i. Diabetes
   1. Renal insufficiency
   2. Congestive Heart Failure
   3. Neuropathy
   4. Gastrointestinal complications
   5. Eye Complications
   6. Coronary Artery Disease
   7. Stroke
   8. Lower extremity vascular disease
ii. Hypertension
   1. Congestive Heart Failure
   2. Stroke
   3. Renal Failure
   4. Blood Pressure Control
   5. BMI
iii. Congestive Heart Failure
   1. Hospitalizations
   2. Weight
   3. ACE
   4. Bet Blockers
   5. Aldactone
   6. Atrial Fibrillation
iv. Coronary Artery Disease
   1. Statin Use
   2. Beta Blocker Use
   3. Procedures
   4. Hospitalizations
v. Mitral Valve Insufficiency
   1. Atrial Fibrillation
   2. Stroke
   3. Valve Repair
   4. Valve Replacement
   5. Congestive Heart Failure
   6. Bacterial Endocarditis
vi. Mitral Valve Prolapse
   1. Mitral Insufficiency
   2. Atrial Fibrillation
   3. Stroke
   4. Valve Repair
   5. Valve Replacement
   6. Congestive Heart Failure
   7. Bacterial Endocarditis
vii. Atrial Fibrillation
   1. Stroke
   2. Congestion Heart Failure
   3. Coronary Artery Disease
viii. Ventricular Arrhythmias
   1. Sudden Death
   2. Syncope
ix. Peripheral Vascular Disease
   1. Statins
   2. Procedures
   3. Amputations
   4. Death
   5. Coronary Artery Disease
x. Obesity (BMI)
   1. Hypertension
   2. Diabetes
   3. Coronary Disease
   4. Breast Cancer
   5. Colon Cancer
   6. GERD
   7. EG Junction Cancer
xi. Asthma
   1. Anti-inflammatory drugs
   2. Peak Flows
   3. Hospitalization
xii. Tobacco addiction
   1. Duration
   2. Education
   3. Anti-Smoking therapy
   4. Coronary Artery Disease
   5. Peripheral Vascular Disease
   6. Stroke
xiii. Alcohol related disease
   1. Hospitalizations
   2. ED Visits
   3. Seizure Disorder
   4. Pancreatitis
   5. Neuropathy
   6. Cerebellar Toxicity
   7. Dementia
xiv. Breast Cancer
   1. Initial Stage
   2. Initial Therapy
   3. Relapse-free survival
   4. Survival
xv. Colon Cancer
   1. Initial Stage
   2. Initial Therapy
   3. Relapse-free Survival
   4. Survival
xvi. Lung Cancer
   1. Initial Stage
   2. Initial Therapy
   3. Relapse-free survival
   4. Survival
xvii. Prostate Cancer
   1. Initial Stage
   2. Initial Therapy
   3. Relapse-free survival
   4. Survival
xviii. Lymphoma, Small Cell Follicular
   1. Initial Stage
   2. Initial Therapy
   3. Relapse-free survival
   4. Survival
xix. Lymphoma, Large Cell Diffuse
   1. Initial Stage
   2. Initial Therapy
   3. Relapse-free survival
   4. Survival
xx. Lymphoma, Hodgkin's Disease
   1. Initial Stage
   2. Initial Therapy
   3. Relapse-free survival
   4. Survival
xxi. Multiple Myeloma
   1. Initial Stage
   2. Initial Therapy
   3. Relapse-free survival
   4. Survival
xxii. Monoclonal Gammopathy of Uncertain Significance
   1. Progression to Multiple Myeloma, Lymphoma, Amyloidosis
xxiii. Chronic Lymphocytic Leukemia
   1. Initial Stage
   2. Initial Therapy
   3. Relapse-free survival
   4. Survival
xxiv. Myelodysplastic Syndrome
   1. Initial Classification
   2. Survival
xxv. Anemia related to Cancer and Chemotherapy
   1. Epoeitin Utilization
   2. Epoeitin Effectiveness
   3. Thrombosis
xxvi. Chemotherapy related complications
   1. Death
   2. Hospitalization
xxvii. Osteoporosis
   1. Drug Therapy
   2. Fractures
   3. Hospitalization
xxviii. Hip fracture
   1. Survival
   2. Post fracture treatment of Osteoporosis
xxix. HIV
   1. HART Therapy
   2. CD 4 count
   3. Hospitalizations
xxx. Tuberculosis
   1. Hospitalizations
   2. Drug Therapy
xxxi. Ulcerative Colitis
   1. Colon Cancer
   2. Hospitalizations
   3. Survival
xxxii. Crohn's Disease
   1. Hospitalizations
   2. Survival
xxxiii. Sprue—Celiac Disease
   1. BMI
   2. Development of Lymphoma
xxxiv. Reflux Esophagitis—Chronic (GERD)
   1. BMI
   2. Proton Pump Inhibitors
   3. Development of GE Junction Cancer
   4. Survival
xxxv. Bisphosphonate Usage
   1. Fracture
xxxvi. Proton Pump Usage
   1. Osteoporosis
   2. Development of GE Junction Cancer
xxxvii. Statins
   1. Survival
   2. Diagnosis of Cancer
xxxviii. Beta Blockers
   1. Survival
xxxix. ACE and ARB drugs
   1. Survival
xl. Estrogens
   1. Breast Cancer
   2. Uterine Cancer
   3. Ovarian Cancer
   4. Coronary Artery Disease
   5. Deep Vein Thrombosis

Medical Education Monitoring 608

A module creates reports useful for medical education, including a case mix for students (608A), a case mix for residents (608B), and procedure note analysis (608C).

Ambulatory/HEDIS Module 610

This module prepares reports relating to ambulatory patient. The module also can also prepare HEDIS reports. HEDIS (Health Plan Employer and Data Information Set) is a set of standardized performance measures designed to ensure that purchasers and consumers have the information they need to reliably compare the performance of managed health care plans. Examples of such reports can include reports which:

1. Identify patients with Chronic illness

2. Survey for preventive therapy (Vaccines)

3. Survey for Preventive Medicine test
a. Mammograms
b. Pap smears
c. PSA
d. Stool for Blood
e. Colonoscopy
f. Cholesterol Measurements
g. Blood Pressure checks
h. Survey for Alcohol abuse

4. Monitor goals for DIABETES:
a. such as Hbg A1C
b. Systolic and Diastolic Blood Pressure
c. LDL and HDL Cholesterol
d. ACE inhibitor utilization
e. Urine Protein (micro-albuminuria)
f. Eye examination

5. Vascular Disease
a. Monitor HDL and LDL Cholesterol
b. Lipid lowering drug utilization
c. Diet education

6. Congestive Heart Failure
a. Ace Inhibitors
b. Beta Blockers
c. Diuretics
d. Aldactone
e. Diet education

7. Prescription Medication Utilization

8. Additional HEDIS Measures

An Emergency Department (ED) Module 612

This module creates report analyzing data pertinent to performance of an emergency department, such as reports which summarize such factors as:

1. Admission Rate

2. Length of Stay before Admission

3. Time to invasive procedure for MI

4. Time to Thombolysis for stroke

5. Code Outcomes

6. Acuity Case Mix

7. Shift variation in acuity and volume

8. Length of stay by acuity

9. Imaging utilization

10. Order set utilization

11. Order utilization

Critical Care Module 614

1. JCAHO ICU Core Measures Reporting
a. ICU-1 Ventilator-Associated Pneumonia (VAP Prevention—Patient Positioning: Numerator Statement: Number of ventilator days where the patient's head of bed (HOB) is elevated equal to or greater than 30 degrees: Denominator Statement: Total number of ventilator days
b. ICU-2 Stress Ulcer Disease (SUD) Prophylaxis: Numerator: Number of ventilator days where patients received SUD prophylaxis: Denominator Statement: Total number of ventilator days
c. ICU-3 Deep Vein Thrombosis (DVT) Prophylaxis: Numerator: Number of ventilator days where patients received DVT prophylaxis: Denominator: Total number of ventilator days.
d. ICU-4 Central Line Associated Primary Blood Stream Infection: Numerator: Number of central line-associated primary bloodstream infections (BSI) by type of ICU: Denominator: Number of central line days by type of ICU
e. ICU-5 Risk Adjusted ICU LOS by type of ICU: Continuous Variable Statement: Mean LOS for ICU patients by type of ICU
f. ICU-6 Risk Adjusted Hospital Mortality for ICU Patients: Numerator: Total number of adult patients having had an ICU stay and whose hospital outcome is death. Denominator: Total number of adult patients having had a qualified ICU stay.

2. Death in Unit

3. Survival, long term

4. Discharge Disposition

5. Multivariate analysis related to survival

6. Sepsis

7. Procedure and complications

8. LOS

9. Ventilator Associated Pneumonia

10. MRSA Infections

11. VRE Infections

12. C.Difficile Infections

13. Drug usage

14. Drug days

15. Central Line Location

16. Central Line Days

17. Infections per Central Line Days

A Revenue Cycle Module (616)

This module analyzes financial performance of the enterprise using the analytics module and generates reports such as

1. Receivable Analysis, including days to collect

2. Cost to collect

3. Revenue sources

4. Admissions/discharge statistics

Enterprise Scheduling Module 618

Resource Utilization 620

This module analyzes data relating to the utilization and allocation of enterprise resources, both physical and personnel, and generates reports, such as reports of service levels, the ability to fulfill a scheduling request, wait time (point of schedule to appointment), office throughput, and waiting room times.

I claim:

1. A medical records information apparatus for use with a clinical database storing clinical data comprising:
an application comprising a set of machine readable code stored on a machine readable medium and executable on a computing platform, the application performing the following processes:
extracting clinical data from a clinical database and loading the extracted data into an analytics database, the analytics database separate from the clinical database;
configuring the analytics database in accordance with a data model optimized for business intelligence reporting tools, and
applying clinically-related logical rules to the clinical data and storing flags associated with the logical rules in the analytics database.

2. The apparatus of claim 1, wherein the data model includes a plurality of fact tables storing clinical data and the flags associated with the logical rules.

3. The apparatus of claim 2, wherein the data model further comprises a plurality of on line analytics processing (OLAP) multi-dimensional data cubes.

4. The apparatus of claim 1, wherein the processes further comprise an update process by which clinical information in the analytics database is periodically updated from information in the clinical database.

5. The apparatus of claim 1, wherein the logical rules are applied to the clinical data using SQL procedures.

6. The apparatus of claim 1, wherein the flags include one or more flags designed to profile a patient for a chronic illness.

7. The apparatus of claim 1, wherein the flags include one or more flags designed to profile compliance with quality measures for care of a patient.

8. A method of facilitating analysis of clinically relevant information contained in a clinical database, comprising the steps of:
performing a backup step including creating a backup to the clinical database to thereby provide a source database for a data extraction program;
performing an extract step including executing the data extraction program and responsively creating a set of metadata tables and extracted source tables;
performing a load step including executing a plurality of procedures to move data from the extracted source tables into a plurality of tables of an analytics database;
wherein the procedures further include procedures applying clinically related logical rules to the data in the extracted source tables and storing flags associated with the logical rules in one or more of the plurality of tables of the analytics database.

9. The method of claim 8, wherein the plurality of tables include a plurality of fact tables and a plurality of dimension tables, the fact tables including at least one of a patient visits table, an orders table, a clinical decision support table, and a cardiology-related table.

10. The method of claim 8, wherein the procedures comprise SQL procedures.

11. The method of claim 8, wherein the flags include one or more flags designed to profile a patient for a chronic illness.

12. The method of claim 8, wherein the flags include one or more flags designed to profile compliance with quality measures for care of a patient.

13. The method of claim 8, further comprising the step of providing a facility by which an organization practicing the method of claim 8 may customize the clinically related logical rules.

14. A system for medical records management comprising:
a computer system including a computing platform executing a medical records information application maintaining a clinical database;
software stored on a machine readable medium accessible to the computing platform creating an analytics database separate from the clinical database;
wherein the analytics database is configured in accordance with a data model optimized for business intelligence reporting tools, and
wherein the analytics database further comprises a plurality of flags set by the application of clinically related logical rules to the clinical data.

15. The system of claim 14, wherein the data model includes a plurality of fact tables storing clinical data and the flags associated with the logical rules.

16. The system of claim 15, wherein the data model further comprises a plurality of on-line analytics processing (OLAP) multi-dimensional data cubes.

17. The system of claim 14, wherein the software further includes instructions performing an update process by which clinical information in the analytics database is periodically updated from information in the clinical database.

18. The system of claim 14, wherein the logical rules are applied to the clinical data using SQL procedures.

19. The system of claim 14, wherein the flags include one or more flags designed to profile a patient for a chronic illness.

20. The system of claim 14, wherein the flags include one or more flags designed to profile compliance with quality measures for care of a patient.
